(19) United States
(12) Patent Application Publication
(10) Pub. No.: US 2021/0165404 A1
(43) Pub. Date: Jun. 3, 2021

(54) AUTONOMOUS SCOOTER SYSTEM

(71) Applicant: Carla R. Gillett, Sacramento, CA (US)

(72) Inventor: Carla R. Gillett, Sacramento, CA (US)

(73) Assignee: Carla R. Gillett, Sacramento, CA (US)

(21) Appl. No.: 17/151,641

(22) Filed: Jan. 18, 2021

Related U.S. Application Data
(63) Continuation-in-part of application No. 16/293,631, filed on Mar. 5, 2019.

(51) Int. Cl. G05D 1/00; H04W 4/40; B60W 60/00; B62K 23/02; B62J 45/20; B62K 11/00; B62J 50/22; G05D 1/02; B60W 10/04; B60W 10/20; G01C 21/36; G01C 21/34; G06Q 30/06; G06Q 50/30; G07C 5/00; G06Q 10/02; G06Q 50/26; G06Q 10/06; H04W 4/024; G01S 19/39

(52) U.S. Cl. CPC G05D 1/0016; B62H 1/00; B60W 60/005; B62K 23/02; B62J 45/20; B62K 11/007; B62J 50/22; G05D 1/0278; B60W 10/04; B60W 10/20; G05D 1/0212; B60W 60/00256; B60W 60/00253; G01C 21/3691; G01C 21/343; G06Q 30/0645; G06Q 50/30; G07C 5/008; G06Q 10/02; G06Q 50/26; G06Q 10/06315; H04W 4/024; G01S 19/39; B60W 2300/365; B60W 2300/367; B60W 2540/215; B60W 2300/405; B60W 2556/60; B60W 2720/10; B60W 2720/12; B60W 2710/20; H04W 4/40

(57) ABSTRACT

Disclosed is an autonomous scooter for personal use for riders to ride hands free since the autonomous scooter drives itself, or they can drive it manually. Respectively the autonomous scooter comprising an autonomous driving mode for personal use or for commercial use to travel to the ideal destination and origin plans where the rider can rent one or more autonomous scooters, and the rider can leave the A-Scooter wherever their destination is. The autonomous scooter is virtually controlled from a control center through tele-communication or a network server to robotically steer with or without a rider onboard. The autonomous scooter in which the rider stands up to ride and may opt to manual control the scooter or use the scooter with hands free during autonomous driving mode with respect to having stabilization to prevent tipping. The control center associated with a rental service plan and a battery charging service plan.

### CROSS REFERENCED TO RELATED APPLICATIONS

A notice of issuance for a continuation in part of in reference to patent application Ser. No. 16/293,631, filing date: Mar. 5, 2019, titled: Autonomous Scooter.

### TECHNICAL FIELD

This disclosure relates generally to autonomous techniques for an autonomous scooter used in ride sharing services, use for delivery services, and use a control center or a network server to control the autonomous scooter operating with or without a rider onboard, and use of a battery charging station for a vehicle.

### BACKGROUND

Motorized electric scooters form factors with two wheels are widely used around the globe. These scooters often rely on a rider to keep the scooter upright during operation. As a result of heavy reliance on a rider for balance and for steering control, these common scooters are typical techniques applied to E-Scooters.

What is needed are intelligent electric scooters like an autonomous scooter provided with a manual driving mode for personal use, and/or provided with an autonomous diving mode for commercial rental service used to for riders to travel to the ideal destinations by using autonomous technology with remote human intervention from a control center through tele-communication or through a preferred network server.

### SUMMARY

The present system offers an autonomous scooter or A-Scooter for personal use and for commercial rental service used to for riders to travel to the ideal destinations hands free since the scooter drives itself. Respectively the present autonomous scooter comprising a manual driving mode for personal use, and an autonomous diving mode for personal use or for commercial use to travel to the ideal destination and origin plans where the rider can rent one or more scooters, and the rider can leave the scooter wherever their destination is by using autonomous technology in tandem with remote human intervention from a control center through tele-communication or a network server. The present autonomous scooter utilizes a modular steering column configured to robotically steer the autonomous scooter with or without a rider onboard. The autonomous scooter in which the rider stands up to ride and may opt to manual control the scooter or use the scooter with hands free during autonomous driving mode. The present invention provides an autonomous scooter characterized as one of; a classified (level 1) having a manual driving mode with respect to the rider self-reliantly controlling the autonomous scooter, or can be classified (level 2) operating in semiautonomous driving mode with respect to the rider's riding plan, or can be classified as (level 3) operating in autonomous driving mode from a control center operator in real-time with respect to sensor and camera imaging data, a navigation system, a stabilizing system which may involve a robotic kickstand with training wheels, or a common kickstand may be utilized, the present invention offers a three wheel autonomous scooter which does not require a kickstand. Ideally the autonomous control system and control center system can be utilized for wirelessly controlling other vehicles like an autonomous bicycle, an autonomous moped, an autonomous motorcycle, an autonomous three-wheeler like a golf cart or an autonomous ATV with respect to having stabilization control from gyroscope or IMU sensors to prevent tipping, as well as having a propulsion system may include a motorized unit transmitted drive force to the rear wheel to propel the autonomous scooter forward. The control center associated with a rental service plan and a battery charging service plan provided by a battery charging station.

### BRIEF DESCRIPTION OF THE DRAWINGS

FIG. 1A and FIG. 1B are perspective views of autonomous scooter 100A and autonomous scooter 100B in accordance with exemplary embodiments of the present invention.

FIG. 1C is back view of a modular steering column 5 for autonomous scooter 100A and autonomous scooter 100B in accordance with exemplary embodiments of the present invention.

FIG. 1D is back view of a modular steering column 5 for autonomous scooter 100B in accordance with exemplary embodiments of the present invention.

FIG. 1E is an illustration of control panel 16 elements in accordance with exemplary embodiments of the present invention.

FIG. 2 is a flowchart illustrating an operation of the autonomous control system 200 in accordance with exemplary embodiments of the present invention.

FIG. 3A is a flowchart illustrating an operation of the control center 300 in accordance with exemplary embodiments of the present invention.

FIG. 3B is a graph illustrating a threshold value for switching driving modes, which changes stepwise with respect to a distance to an obstacle in accordance with exemplary embodiments of the present invention.

FIG. 4 is a graph illustrating the threshold value for switching to manual driving mode 304, which linearly changes with respect to the distance to the obstacle in accordance with exemplary embodiments of the present invention.

FIG. 5 is a graph illustrating the threshold value for switching to autonomous driving mode 306 with respect to the distance to the obstacle and a type of the obstacle in accordance with exemplary embodiments of the present invention.

FIG. 6 is a flowchart of a method of operating a tele-communication system 600 in accordance with exemplary embodiments of the present invention.

FIG. 7 is an autonomous scooter 100 battery charging system 700 in accordance with exemplary embodiments of the present invention.

### DETAILED DESCRIPTION OF THE DRAWINGS

The present disclosure provides various modes of autonomous transportation vehicles which can hired for personal use and for commercial rental service used to for riders to travel to the ideal destinations, respectively the present invention is an autonomous scooter comprising a manual driving mode for personal use, and an autonomous diving mode for personal use or for commercial use to travel to the ideal destination and origin plans where the rider can rent one or more scooters, and the rider can leave the scooter wherever their destination is by using autonomous technology in tandem with remote human intervention from a control center through tele-communication or a network server. The present autonomous scooter (A-Scooter) utilizes a modular steering column configured to robotically steer the autonomous scooter with or without a rider onboard, these services and unique operations are disclosed hereafter.

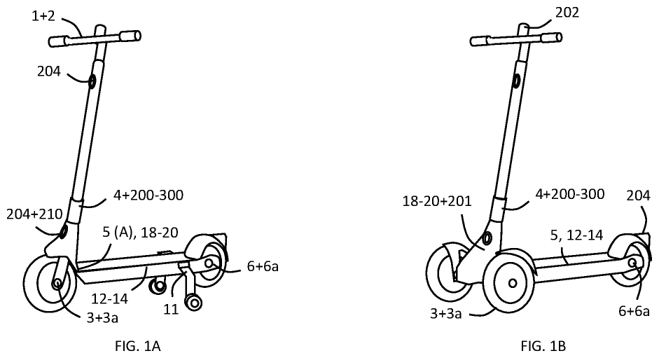

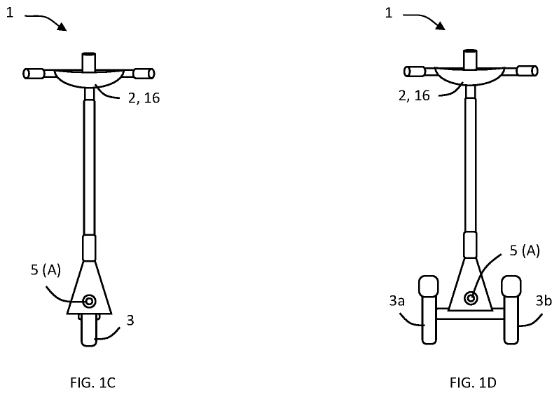

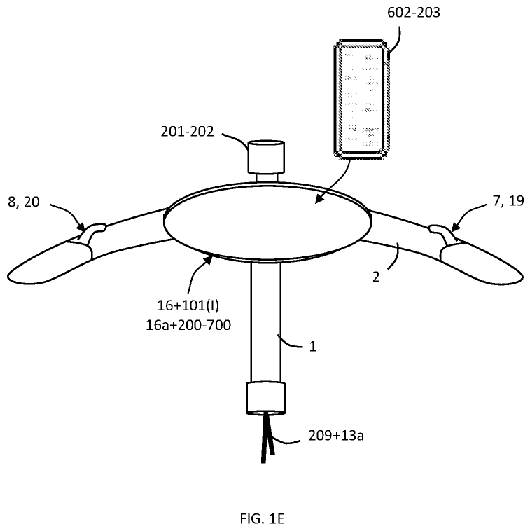

In greater detail FIG. 1 is an autonomous scooter 100 characterized as an autonomous scooter 100 having a modular steering column 1 connected to a handlebar 2 for changing the direction of the front wheel 3 via a rider 101. Accordingly, the modular steering column 1 and handlebar 2 are to manually steer. The modular steering column 1 is connected to a steering actuator 4, and the steering actuator 4 is spaced at a lateral location of a deck 5 and is affixed thereon, the deck 5 is connected to a rear wheel 6 via a rear wheel hub 6a, the deck has a wide platform allowing the rider 101 stands up to ride, accordingly the rider 101 and may opt to manual control the scooter or use the autonomous scooter with hands free during autonomous driving mode.

The head tube 1a of the modular steering column 1 supported for rotation relative to the handlebar 2 is to manually steer the autonomous scooter 100 during manual driving mode 304, or the steering actuator 4 is to steer the autonomous scooter 100 101 during autonomous driving mode 306.

The modular steering column comprises a throttle controller 7 electrically connecting to controllers 9 of various electronic motors/actuators, comprises a brake controller 8 electrically connecting to a brake device 8(BD).

In various elements the throttle controller 7 and the brake controller 8 that is attached to the handlebar 2 of the modular steering column 1 and both handles can be operated by a rider 101, or an alternative is possible in which the throttle controller 7 and the brake controller 8 are systematically controller by an onboard navigation system 205 or remotely through a control center 300. Wherein the throttle controlling connecting to at least one electronic motor 3a/3b, the brake controller 8 connecting to at least one brake device 9 of a front wheel 3, or a brake device 9 rear wheel 6.

An electric propulsion system 10A for a front wheel 3 may include an electronic hub motor 3a attached to the lower end of the front hub 3b to propel the autonomous scooter 100 forward, the rear wheel 6 may include an electronic hub motor 6a attached of the rear hub 6b to propel the autonomous scooter 100 forward, or a propulsion system 10B may be a rear wheel 6 rotatably connected to a motorized sprocket and belt or chain causing rotational driving force to be transmitted to the rear wheel 6 via a sprocket linked to a belt or chain to propel the rear wheel 5 forward.

Alternatively, the brake device 9 may use a rim brake that presses a brake shoe that operates by operating a brake lever against a rim 3c of a front wheel 3, or the rear wheel 5, a roller brake, or a coaster brake may be provided on the rear rim 5c of the rear wheel 5 to be braked by manually when the brake controller 8 is manually activated by the rider 101, whereby the thumb of the rider presses the throttle lever, respectively.

In some embodiments, the foot brake is further configured to rotate about a pivot axis when the foot brake is pressed down. In addition, the foot brake can be further configured to return to its un-pivoted position when the foot brake is no longer pressed down. In some embodiments, a rear portion of the deck comprises the foot brake. In other embodiments, the foot brake and the deck are separate, respectively the foot brake to apply a braking force to the rear wheel 6. The method can further comprise identifying a location of the foot brake by sensing a plurality of ridges on the foot brake, (not drawn).

In various elements the common kickstand 11 can be manually activated by the rider 101 for a two wheel autonomous scooter when parked.

In various elements an automated kickstand 11(AK) or (robotic) kickstand with training wheels can be autonomously activated to maintain an upright position without during autonomous driving mode 306, respectively the automated kickstand 11(AK) maintains the vertical axis with respect to keeping the autonomous scooter 100 upright.

In various elements the automatic kickstand 11(AM) may be configured with actuating motors to raise and lower during manual driving mode 304, the automatic or (robotic) kickstand with training wheels can be detached by the rider who prefers a common kickstand.

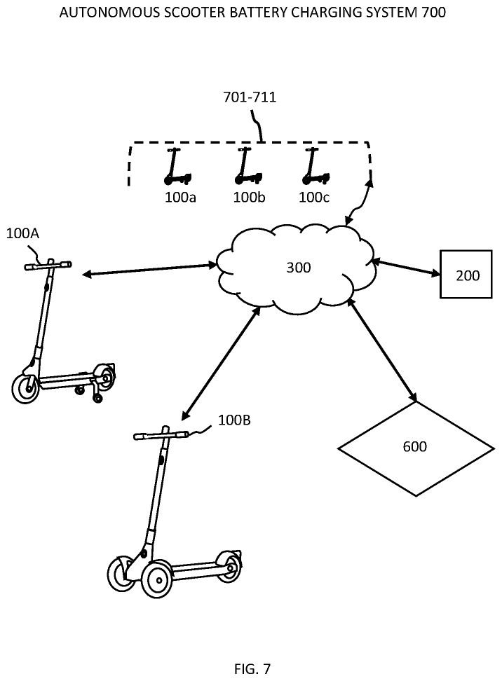

In various elements an electrical system 12 and a battery system 13 which is managed by an autonomous scooter 100 battery charging system 700, as detailed in FIG. 7 through the autonomous control system 200 based on a service plane of the control center 300.

Accordingly the battery system 12 to receive an electrical connection via wiring 12(W) linking regulated battery power 14(BP) to system components, the autonomous scooter 100 battery charging system 700 is to charge batteries 14a. Wherein the internal battery system 13 to provide a dock mechanism 15 regulated battery power 14(BP) from a battery pack with lithium batteries, or may include a secondary battery pack which is interchangeable. Wherein the electrical system 12 and wiring 12(W) connect the battery system 13 to internal electrical components of the autonomous scooter 100 to external auxiliary components such as a control panel 16, lights, horn, audio speakers, sensors, cameras, etc.

Alternatively, another example of the battery charging element can use a capacitor which may involve batteries charged by autonomous scooter 100 battery charging system 700 whereby a first battery 14b or a secondary battery to be automatically charged.

In greater detail FIG. 1C is the modular steering column 5 for autonomous scooter 100A and autonomous scooter 100B in accordance with exemplary embodiments of the present invention.

In greater detail FIG. 1D is the modular steering column 5 for autonomous scooter 100B in accordance with exemplary embodiments of the present invention.

In greater detail FIG. 1E is a diagram of the control panel 16 for rider interface 101(1), the control panel 16 may be situated between the handlebar 2 in view of the rider 101. The control panel 16 may comprise a virtual display with menu 17 for rider interface 101(1).

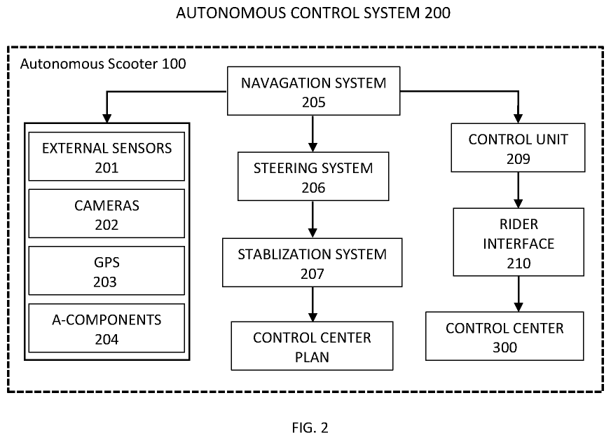

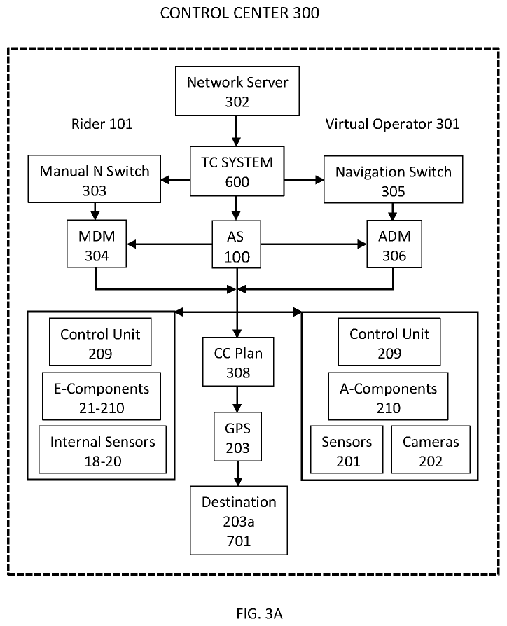

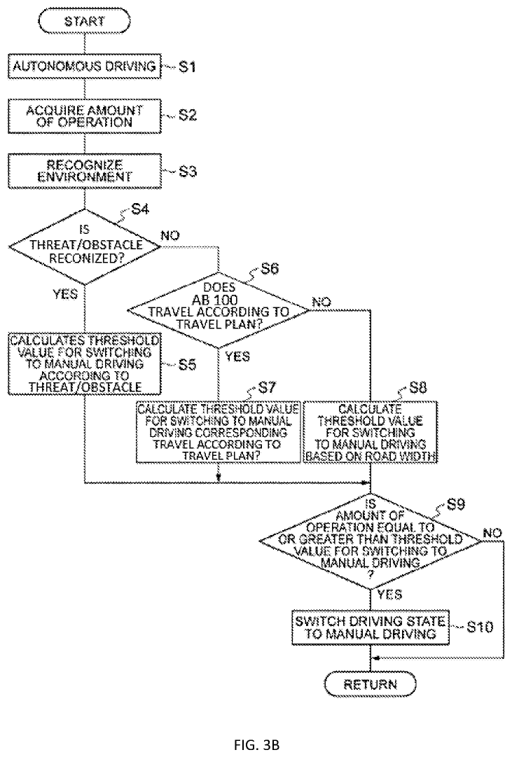

Accordingly, the rider interface 101(1) via a virtual a touch screen menu 17 displays control settings and performance status of autonomous scooter 100 provided from a control unit 209 linked to external sensors 201, cameras 202, and GPS 203 the sensor which may involve one of; LIDAR, radar, GPS routes 203a, electronic components 210 like Gyros 210a, IMU 210b having stabilization to prevent tipping, software 605 hardware 210c, linked to the control panel 16. The control unit 209 then storing performance data to memory in Cloud. Accordingly, the rider provides wireless instruction via a smartphone connected therein providing Internet, WIFI, Bluetooth and mobile APPs. Wherein an APP having programming systematically receives rider input in accordance with linked information received from sensor data to manually navigate the autonomous scooter 100a/100B to selected geographic areas and the like, the system components 1-16 are associated with systems 200-300 detailed in FIG. 2 and FIG. 3.

Other communications in which the control center plan may involve one of renting an autonomous scooter 100 for delivering a payload to a rider-selected starting location established to pick-up order, the payload may be carried or stored in a basket 18 set on the front section of the handlebar 2, or other storage compartment; the order information to store in memory.

In some embodiments, components of the autonomous scooter 100 comprises plastic, carbon fiber, metal and other elements.

Accordingly the modular steering column 1 may be utilized by an autonomous scooter 100 having seats like, autonomous bicycles, autonomous tricycles, autonomous mopeds, and autonomous motorcycles configured at least one function based on a riders plan 101(RP) which may involve the rider 101 wirelessly linking her or his smart 211 device (iPad, Tablet, PC, etc.) or smartphone 602 via Wi-Fi, Bluetooth or use a preferred APP to interface with the autonomous scooter 100's controller such that the rider 101 can communicate remotely or control the autonomous scooter 100 system remotely via her or his smartphone 602 to generate GPS routes 203a for the rider 101 of the autonomous scooter 100 based on a rider-selected starting location and based on a rider-selected destination location based on the action of the rider whilst riding. The following paragraphs disclose the autonomous control system 200 configured with combinations of external sensors 201, cameras 202, and GPS 203 all linked to a navigation system 205 indicative of whichever rider's plan during manual navigation or indicative of a control center 300 driver 301 controlling steering, velocity, and position of the autonomous scooter 100, exampled herein.

In greater detail FIG. 2 is a diagram of the autonomous control system 200 configured for accomplishing at least one function involving a plan for an autonomous scooter 100 operating with or without a rider onboard. The present autonomous scooter may be characterized as one of; a classified (level 1) having a manual driving mode with respect to the rider self-reliantly controlling the autonomous scooter 100, or can be classified (level 2) operating in semiautonomous driving mode with respect to the rider's riding plan, or can be classified as (level 3) operating in autonomous driving mode from a control center operator in real-time with respect to sensor and camera imaging data, a navigation system, a stabilizing system which may involve a robotic kickstand with training wheels, or a common kickstand may be utilized, the present invention offers a three wheel autonomous scooter which does not require a kickstand. Ideally the autonomous control system and control center system can be utilized for wirelessly controlling other vehicles like an autonomous bicycle, an autonomous moped, an autonomous motorcycle, an autonomous three-wheeler like a golf cart or an autonomous ATV with respect to having stabilization control from gyroscope or IMU sensors to prevent tipping. the following elements can be applied to accommodate driving systems of electric autonomous scooters 100.

Respectively the autonomous scooter 100 operates by manual control, operates remotely by a control center 300 or operated with a combination of both to control steering directions and propulsion of the autonomous scooter 100 via an autonomous control system 200 which is configured to manual navigation switch 303 from a manual driving mode 304 to an autonomous driving mode 306, or vice versa when indicative of a rider's plan 101(RP) accordingly when the autonomous scooter 100 is manned or when the autonomous scooter 100 is unmanned. Respectively the navigation system 205 is systematically linked via the control unit 209 to a stabilization system which receives data signals from the gyros sensors and/or IMU sensors monitoring balance states of the autonomous scooter 100. Respectively the navigation system 205 is systematically linked via the control unit 209 to a steering system which receives data signals from the steering actuator sensor.

The autonomous control system 200 utilizes the control center 300 configured to implement an autonomous driving mode 306 state indicative of a rider's plan 101(P) or indicative of a control center plan 208 executed by a virtual operator in real-time, wherein the control center 300 is in contact with the autonomous scooter 100 when the rider is presently onboard or when the rider is not presently onboard. The control center 300 generates a control center plan 208 with respect to feedback of external sensors including LIIDAR 201a and/or radar 201b which detect threats and obstacles in an environment of the autonomous scooter 100 during manual navigation or during autonomous navigation, the navigation system associated with determining GPS routes based on a control center plan 208.

The control unit 209 outputs a control signal corresponding to the control center plan 208 to the control unit 209, in this way, the control unit 209 controls the travelling of the autonomous scooter 100 such that the autonomous driving mode 306 can be executed according to the control center plan 208. In addition, when the amount of operation acquired by the operation amount acquisition unit is equal to or greater than the threshold value for switching to manual driving mode 304 calculated by the calculation unit step, the control unit 209 can switch the driving state from autonomous driving mode 306 to manual driving mode 304 which is detailed in FIG. 3A.

For example, the communication path of autonomous scooter 100 can include wireless rider interface within, optical communication, ultrasonic communication, or the combination thereof. For example, satellite communication, cellular communication, Bluetooth connecting with the rider terminal via Wi-Fi or Bluetooth®, Infrared Data Association standard (IrDA), wireless fidelity (Wi-Fi), and worldwide interoperability for microwave access (WiMAX) are examples of wireless communication that can be included in the communication path. Cable, Ethernet, digital subscriber line (DSL), fiber optic lines, fiber to the home (FTTH), and plain old telephone service (POTS) are examples of wired communication that can be included in the communication path. Further, the communication path can traverse a number of control center 300 topologies and distances. For example, a communication path can include direct connection, personal area network (PAN), local area network (LAN), metropolitan area network (MAN), wide area network (WAN), or a combination thereof. The control system 101 can further execute software 605 programming to include interaction with the communication path the connect rider interface 101(1) with a virtual operator 301 at the control center 300.

For example, the navigation system 205 utilizes detection devices configured to detect an external situation which is peripheral information of the autonomous scooter 100 in which LIDAR 201a detects the obstacle outside the autonomous scooter 100 using light. The LIDAR 201a transmits the light to the surroundings of the autonomous scooter 100, measures the distance to the reflection point by receiving the light reflected from the obstacle, and then, detects the obstacle. The LIDAR 201a can output, for example, the distance or direction to the obstacle as the obstacle information of the obstacle. The LIDAR 201a outputs the detected obstacle information to the autonomous scooter 100.

For example, the navigation system 205 utilizes detection devices configured to detect an external situation which is peripheral information of the autonomous scooter 100 having radar 201b which detects an obstacle outside of the autonomous scooter 100 using a radio wave. The radio wave is, for example, a millimeter wave. The radar 201b detects the obstacle by transmitting the radio wave to the surroundings of the autonomous scooter 100 and receiving the wave reflected from the obstacle. The radar outputs, for example, the distance or direction to the obstacle as obstacle information of the obstacle. The radar outputs detected obstacle information to the autonomous scooter 100. In a case of performing sensor fusion, the received information on the reflected radio wave may be output to the autonomous scooter 100.

In a case of performing sensor fusion, the received information on the reflected light may be output to the autonomous scooter 100. The LIDAR 201a, and the radar 201b are not necessarily provided in an overlapping manner.

For example, external cameras 202 providing imaging of an external situation of the autonomous scooter 100. The camera 202 is, for example, provided on the frame sections of the autonomous scooter 100. The camera 202c may be a monocular camera 202a or may be a stereo camera 202b. The stereo camera 202c has, for example, two imaging units that are arranged so as to reproduce a binocular parallax. The image information of the stereo camera 202c also includes information on the depth direction. The camera 202 outputs the image information relating to the external situation to the of the autonomous scooter 100. In addition, the camera 202 may be an infrared camera 202d or a visible light camera 202e.

For example, GPS 203 receives signals from three or more GPS satellites and acquires position information indicating the position of the autonomous scooter 100. The latitude and the longitude of the autonomous scooter 100 may be included in the position information. The GPS 203 receiver 203a outputs the measured position information of the autonomous scooter 100. Instead of the GPS 203 another means for specifying the latitude and the longitude at which the autonomous scooter 100 is present may be used.

The map database 203a is a database in which map information is included. The map database 203a is formed, for example, in a hard disk drive (HDD) mounted on the autonomous scooter 100. In the map information, for example, position information of roads, information on road types, and position information of intersections, and branch points are included. For example, type of a curve or a straight portion and a curvature of the curve are included in the information on the road type.

Furthermore when engaged by the navigation system 205, the autonomous driving mode 306 adjust position information for simultaneous localization and mapping technology (SLAM), the map information may include an output signal of the external sensors 201, cameras 202 and the GPS map database 203a may be stored in a computer in a facility such as an information processing center which is capable of communicating with autonomous scooter 100.

For example, the navigation system 205 is a device configured to perform guidance to a destination set on the map by a rider 101 and calculates a travelling route of the autonomous scooter 100 based on the position information of the autonomous scooter 100 measured by the GPS 203 uses a receiver and the map information in the map database 203a. The route may be a route on which a travelling lane is specified, in which the autonomous scooter 100 travels in a multi-lane section.

The navigation system 205 calculates, for example, a target route from the position of the autonomous scooter 100 to the destination and performs notification to the rider 101 by auxiliary devices 204 like lights 204a, speakers 204b, microphone 204c. The navigation system 205, for example, transmits the target route information of the autonomous scooter 100.

As other communications between the tele-communication system 600 and the smart device 211, 602 are possible for instance, GPS 203 using a receiver 203a and map information 203b if the tele-communication system 600 is unable to receive GPS satellite signals or generate GPS coordinates, the tele-communication system 600 can query the smart device 211, 602 to obtain GPS coordinates 202c.

For example, the control panel 16 is configured to perform an input and output of the information between the rider 101 of the autonomous scooter 100, accordingly wherein the control panel 16 includes a display panel 16a for displaying the image information, input operation data and output operation data for the rider to review. For example, the rider 101 may wirelessly link her or his mobile phone, the autonomous scooter 100's control unit through wireless communication involving one of Wi-Fi, Bluetooth, or a tele-communication to provide feedback to the rider via the control panel 16, and incorporates sensor input for monitoring movement based on the action of the rider whilst riding.

For example, the autonomous scooter 100 system may utilize a service plan may involve one of renting an autonomous scooter 100 for delivering a payload to a preselected starting location established to pick-up order, and may provide one or more storage compartments for transporting the delivery payload to a delivery location.

For example, the tele-communication path of autonomous scooter 100 can include wireless rider interface method of controlling the rented autonomous scooter 100, comprising the steps of: storing a software 605 application for remotely controlling the unmanned autonomous scooter 100; establishing a short-range wireless tele-communication link between the autonomous scooter 100 when the smartphone 602 is at the autonomous scooter 100; receiving data via the short-range wireless communication link from the autonomous scooter 100 that is used by the software 605 application to display a menu of telematics service selections to the control center driver; receiving a service selection that is chosen from one of the displaying the service selections; and transmitting a command that controls at least one function of the autonomous scooter 100 based on the received the service selection from over the short-range or long range wireless tele-communication link.

The auxiliary components or (A-components 204) linked to the control panel 16, are manually switched on the rider on switched on by the CC drive 201, wherein subsystem devices may include a telematics Control Unit (TCU) or (telematics unit 601) may involve: receiving data via the short-range wireless communication link from the telematics unit 601 that is used by the software 605 application to display a menu of telematics service selections on a smartphone having a mobile APP; transmitting a command that controls at least one function of the autonomous scooter 100 based on the received telematics service selection from the smartphone or provide other indicative instruction.

The autonomous control system 200 accordingly may involve an operation amount acquisition unit providing; an environment recognition unit, a control center plan 208 generation unit, thusly as the above-described operation amount acquisition unit is performed by loading the program stored in the ROM into the RAM and executing the control unit programming, a central processing unit (CPU), read only memory (ROM), random access memory (RAM), and various processes and steps exampled herein.

The operation amount acquisition unit acquires the amount of the steering operation, the acceleration operation and the braking operation by the rider 101 of the autonomous scooter 100 during the autonomous driving mode 306 based on the information acquired by the internal sensor 203. The amount of operation is, for example, the steering angle of the modular steering column 1, the steering torque with respect to the modular steering column 1, the amount of depression on the throttle controller 7, the amount of depression on the brake controller 8, or the operation force on the brake controller. Alternatively, the amount of operation may be a duration of a state in which the steering angle of the modular steering column 1, the steering torque with respect to the modular steering column 1, the amount of depression on the throttle controller, the amount of depression on the brake controller, or the operation force on the brake controller is equal to or greater than a threshold value set in advance. The operation amount acquisition unit may also be configured as an operation amount acquirer.

The environment recognition unit step recognizes the surrounding environment of the autonomous scooter 100 based on the information acquired by one or more of the external sensor 201-202, the GPS 202, receiver 202a, and the map database 202b. The environment recognition unit step includes an obstacle recognition unit step, a road width recognition unit step, and an object recognition unit step. The obstacle recognition unit step recognizes the obstacle around the autonomous scooter 100 as a status of the surrounding environment of the autonomous scooter 100 based on the information acquired by the external sensors 201.

For example, a pedestrian, another AS 100, a moving object such as a common motorcycle or a common scooter, a lane boundary line (lane line, yellow line), a stationary object such as a curb, a guardrail, a pole, a median strip, a building, or a tree may be included in obstacles recognized by the obstacle recognition unit step. The obstacle recognition unit step acquires information on one or more of a distance between the obstacle and the autonomous scooter 100, a position of the obstacle, a relative speed of the obstacle with respect to the autonomous scooter 100, and a type of obstacle. The type of obstacle may be identified as a pedestrian, another AS 100, a moving object or a stationary object. The environment recognition unit step may be configured as an environment recognizer. Furthermore, the obstacle recognition unit step may be configured as an obstacle recognizer.

The road width recognition unit step recognizes a road width of the road on which the autonomous scooter 100 travels as the surrounding environment of the autonomous scooter 100 based on the information acquired by one or more of the external sensors.

The control center 300 recognizes whether or not the autonomous scooter 100 control center plan 208 is a route for traveling on a scooter lane, sidewalk, on a street, or driving through an intersection or a parking lot as the surrounding environment in which the autonomous scooter 100 control center plan 208 or riders plan 101(RP) is based on one or more of the map information acquired by the map database and the position information of the autonomous scooter 100 acquired by the GPS 203. For example, as the surrounding environment of the autonomous scooter 100 based on the map information and position information of the autonomous scooter 100, in which the road has potential threats or obstacles.

The generation unit generates a control center plan 208 for the autonomous scooter 100 based on the information on the target route calculated by the navigation system 205, the information of the obstacle around the autonomous scooter 100 recognized by the environment recognition unit step, and the map information acquired by the map database. The control center plan 208 is a trajectory of the autonomous scooter 100 on the target route. For example, a speed, an acceleration, a deceleration, a direction, and a steering angle of the autonomous scooter 100 may be included in the control center plan 208. The control center plan 208 may involve a generation unit which generates a control center plan 208 such that the autonomous scooter 100 can travel while satisfying standards such as a safety, regulatory compliance, and driving efficiency on the target route. Furthermore, the control center plan generation unit generates a control center plan 208 for the autonomous scooter 100 so as to avoid contact with an obstacle based on the situation of the obstacle around the autonomous scooter 100.

In greater detail FIG. 3A is a chart of the control center 300, accordingly the control center is wirelessly in communication with the autonomous control system 200 and the control unit 209. The control center 300 is configured to control the travelling of the autonomous scooter 100 based on the control center plan 308 generated by the control center plan generation unit 309 and executed by the autonomous drive mode 205 when the rider 101 is not engaged (paying attention) or distracted, or when the autonomous scooter 100 is unmanned.

For example, a preferred mobile APP may be configured or the rider to interface with the autonomous scooter 100 such that the rider can communicate with the autonomous scooter 100 system or communicate with a control center remotely 310.

The control center 300 is configured to control the travelling of the autonomous scooter 100 based on the control center plan 308 generated by the control center plan generation unit and executed by the autonomous drive mode 205 when the rider 101 is not engaged (paying attention) or distracted, or when the autonomous scooter 100 is unmanned.

The control center 300 provide one or more remote drivers 301 whom receive inputs/outputs via signal corresponding to various signals from the control unit 209 pair with the autonomous scooter 100. In this way, the control center 300 controls the travelling of the autonomous scooter 100 such that the autonomous driving mode 306 of the autonomous scooter 100 can be executed according to the control center plan 208 for driving to a destination 209/210, the destination may apply to a job generated from the control center indicative of the rider's plan 101(RP) as well as indicative of the control center's plan 308.

The control center 300 is in control of a manual navigation switch 303 for switching to manual driving mode 304 and the navigation switch 305 into autonomous driving mode 306. In addition, the control center operation or (remote driver 301) is to instruct the control unit 209 by remote interface methodology to provide procedure involving an operation to switch 305 to manual driving mode 304 calculated by the calculation unit step, the control center 300 via the control unit to switch 305 the autonomous driving mode 306 back to manual driving mode 304, switching process examples are detailed in FIG. 3B.

The control center 300 is systematically connected to the autonomous scooter 100's electronic components (E-Components) internal/external sensors 21-210, the external sensors, cameras, GPS, providing data of manual driving mode 304 and providing data from autonomous driving mode 306 to the remote operation 301. Systematically via programming a computer of the control center 300 provides a calculation unit processors for calculating the threshold value for switching to manual driving mode 304 according to the surrounding environment of the autonomous scooter 100 recognized by the environment recognition unit step. As described below, when the obstacle is recognized by the obstacle recognition unit step of the environment recognition unit step, the calculation unit step may calculate the threshold value for switching 305 to manual driving mode 304 according to the distance between the obstacle and the autonomous scooter 100 and the type of obstacle. In addition, when the obstacle is not recognized by the obstacle recognition unit step of the environment recognition unit step, the calculation unit step may calculate the threshold value for switching 305 to manual driving mode 304 according to one or more of the road width of the road on which the autonomous scooter 100 travels and a type of facilities such as a parking lot on which the autonomous scooter 100 travels. As described below, a function describing the threshold value for switching 305 to manual driving mode 304 corresponding to the surrounding environment of the autonomous scooter 100 is stored in the autonomous scooter 100. The calculation unit step may be configured as a calculator.

For example various processors providing instruction data, performance data, rider data, or external linked data.

For example, the autonomous control system 200 comprising a steering system which may involve steering actuators, controllers, gyroscope or inertial measurement units for controlling motion and balance of the autonomous scooter 100 utilized indicative with a rider's plan 101(RP).

For example, the autonomous scooter's 100 control unit 209 configured to determine the current position of the autonomous scooter 100 based on the action of the rider whilst riding.

For example the autonomous scooter 100 system may involve a CC Plan 313 may involve an autonomous scooter 100 to be scheduled for delivering a payload to a rider-selected starting location established to pick-up order 312 or scheduling a trip to a nearby autonomous scooter battery charging station 701 which is CC plan 316 or other numbering indicated in FIG. 7.

For example the control panel 16 providing a virtual readout of real-time performance data pertaining to one or more operations of the electronic components; receive scheduling information corresponding to a location requesting to pick-up delivery order 312; confirm a rider-selected starting location established to pick-up order then, delivery the order to a rider-selected destination location 313; delivering the payload to a rider-selected destination location or to a recipient 314, whereby the payload is stored in a container, basket, saddlebags, or other storage compartment; provide memory configured to store map information including road information and preselected pick-up stops 315.

In greater detail FIG. 3B, the control unit 209 of the autonomous scooter 100 executes the autonomous driving mode 306 of the autonomous scooter 100 based on the control center plan 208 may be accomplished by the following step examples: First using a control unit 209; (S1). In starting the autonomous driving mode 306, for example, when an ignition of the autonomous scooter 100 is turned ON, the control unit 209 determines whether autonomous driving mode 306 can be executed or not based on the surrounding environment of the autonomous scooter 100 recognized by the external sensor 201, camera 202, GPS 203 and the environment recognition unit step of the autonomous scooter 100. When it is determined that autonomous driving mode 306 can be executed, the control unit 209 notifies the rider 101 though the autonomous scooter 100 of the fact that autonomous driving mode 306 can be executed. By the rider 101 performing a predetermined input operation to the autonomous scooter 100, the autonomous driving mode 306 device 100 starts autonomous driving mode 306. The operation amount acquisition unit of the autonomous scooter 100 acquires the amount of any of the steering operation, the acceleration operation and the braking operation by the rider 101 of the autonomous scooter 100 during the autonomous driving mode 306 (S2).

The environment recognition unit step recognizes the surrounding environment of the autonomous scooter 100 (S3). When the obstacle recognition unit step of the environment recognition unit step recognizes an obstacle around the autonomous scooter 100 as information relating to a status of the surrounding environment of the autonomous scooter 100 (S4), the calculation unit step calculates the threshold value for switching to manual driving mode 304 corresponding to the obstacle (S5). The obstacle recognition unit step of the environment recognition unit step may recognize a presence or position, for example, of the obstacle as information relating to the status of the surrounding environment.

Hereinafter, the calculation of the threshold value for switching to manual driving mode 304 corresponding to the obstacle by the calculation unit step will be described. For example, a function describing the threshold value for switching to manual driving mode 304 with respect to the distance between the obstacle and the autonomous scooter 100 is stored in the autonomous scooter 100. In the example in FIG. 3, when the distance between the obstacle and the autonomous scooter 100 exceeds a value of 2, the calculation unit step calculates a threshold value for switching to manual driving mode 304 Th.sub.0 which is a reference of the threshold value for switching to manual driving mode 304. On the other hand, when the distance between the obstacle and the autonomous scooter 100 is equal to or less than 2, the calculation unit step calculates a threshold value for switching to manual driving mode 304 Th.sub.1 which is lower than Th.sub.0. In the above example, the function describing the threshold value for switching to manual driving mode 304 with respect to the distance between the obstacle and the autonomous scooter 100 comprises a stepwise function.

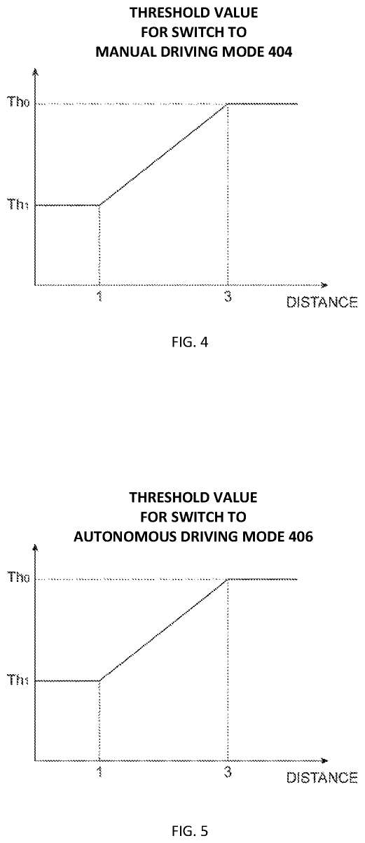

In addition, a function describing the threshold value for switching to manual driving mode 304 with respect to the distance between the obstacle and the autonomous scooter 100 as illustrated in FIG. 4 may be stored in the autonomous scooter 100. In the example in FIG. 4, when the distance between the obstacle and the autonomous scooter 100 exceeds a value of 3, the calculation unit step calculates a threshold value for switching to manual driving mode 304 Th.sub.0 which is a reference of the threshold value for switching to manual driving mode 304. When the distance between the obstacle and the autonomous scooter 100 is equal to or less than 1, the calculation unit step calculates a threshold value for switching to manual driving mode 304 Th.sub.1 which is lower than Th.sub.0. When the distance between the obstacle and the autonomous scooter 100 is equal to or lower than 3 and exceeds 1, the calculation unit step calculates a threshold value for switching to manual driving mode 304 which linearly decreases from the threshold value for switching to manual driving mode 304 Th.sub.0 at the time when the distance is 3 to the threshold value for switching to manual driving mode 304 Th.sub.1 at the time when the distance is 1 as the distance between the obstacle and the autonomous scooter 100 becomes smaller. In the above example, the function describing the threshold value for switching to manual driving mode 304 with respect to the distance between the obstacle and the autonomous scooter 100 comprises a linear function. However, a non-linear function may be included in which the rate of decrease from the threshold value for switching to manual driving mode 304 Th.sub.0 at the time when the distance is 3 to the threshold value for switching to manual driving mode 304 Th.sub.1 at the time when the distance is 1 increases or decreases as the distance becomes closer to 1 or 3.

As FIG. 3B further examples, when the obstacle recognition unit step does not recognize an obstacle around the autonomous scooter 100 (S4) and the facility recognition unit step of the environment recognition unit step recognizes that the autonomous scooter 100 travels on an intersection or parking lot (S6) as information relating to a status of the surrounding environment of the autonomous scooter 100, the calculation unit step calculates the threshold value for switching to manual driving mode 304 corresponding to the intersection and the parking lot recognized by the facility recognition unit step (S7). The facility recognition unit step can recognize the fact that, for example, the autonomous scooter 100 travels on an intersection by detecting a blinking of a traffic signal using the external sensor 201, camera 202 or by the information acquired by the GPS 203. In addition, the facility recognition unit step can recognize the fact that the autonomous scooter 100 travels on a parking lot by detecting external signs, such as a mark “P”, using the external sensor 201-205 or by the information acquired by the GPS 201a. Respectively, even when the obstacle recognition unit step does not recognize an obstacle around the autonomous scooter 100 (S4) and the facility recognition unit step of the environment recognition unit step does not recognize that the autonomous scooter 100 travels on an intersection or a parking lot (S6) as information relating to a status of the surrounding environment of the autonomous scooter 100, the calculation unit step may calculate the threshold value for switching to manual driving mode 304 based on the road width recognized by the road width recognition unit step of the environment recognition unit step (S8).

A function describing the threshold value for switching to manual driving mode 304 with respect to the parking lot scenario for example, the calculation unit step calculates a threshold value for switching to manual driving mode 304 Th.sub.0 which is a reference of the threshold value for switching to manual driving mode 304. On the other hand, when the autonomous scooter 100 travels in the parking lot, the calculation unit step calculates a threshold value for switching to manual driving mode 304 Th.sub.p which is lower than Th.sub.0.

Alternatively, a function of the threshold value for switching to manual driving mode 304 with respect to a predetermined time before the autonomous scooter 100 enters the intersection and at a predetermined time after passing through the intersection, the calculation unit step calculates a threshold value for switching to manual driving mode 304 Th.sub.0 which is a reference of the threshold value for switching to manual driving mode 304. When the autonomous scooter 100 travels in the intersection, the calculation unit step calculates a threshold value for switching to manual driving mode 304 Th.sub.c which is lower than Th.sub.0.

During the time from a predetermined time before the autonomous scooter 100 enters the intersection to a time when the autonomous scooter 100 enters the intersection, the calculation unit step calculates a threshold value for switching to manual driving mode 304 which linearly decreases from the threshold value for switching to manual driving mode 304 Th.sub.0 to the threshold value for switching to manual driving mode 304 Th.sub.c as the autonomous scooter 100 becomes closer to the intersection. During the time from when the autonomous scooter 100 passes through the intersection to a time when a predetermined time has elapsed, the calculation unit step calculates a threshold value for switching to manual driving mode 304 which linearly increases from the threshold value for switching to manual driving mode 304 Th.sub.c to the threshold value for switching to manual driving mode 304 Th.sub.0 as the autonomous scooter 100 moves away from the intersection. In a similar manner, the calculation unit step can calculate a threshold value for switching to manual driving mode 304 when the autonomous scooter 100 travels on a GPS route 203a. Although the above examples have been described with respect to a functional relationship between the threshold value for switching to manual driving mode 304 and time, the relationship may be based on a distance or a positional relationship with respect to the intersection.

A function describing the threshold value for switching to manual driving mode 304 with respect to the road width when the road width exceeds an ordinary width, the calculation unit step calculates a threshold value for switching to manual driving mode 304 Th.sub.0 which is the reference of the threshold value for switching to manual driving mode 304. When the road width is a minimum width in which the autonomous scooter 100 can travel, the calculation unit step calculates a threshold value for switching to manual driving mode 304 Th.sub.min which is a minimum value of the threshold value for switching to manual driving mode 304. When the road width is equal to or less than the ordinary width and exceeds the minimum width, the calculation unit step calculates a threshold value for switching to manual driving mode 304 which linearly decreases from the threshold value for switching to manual driving mode 304 Th.sub.0 of the ordinary width to the threshold value for switching to manual driving mode 304 Th.sub.min of the minimum width as the road width becomes narrower. The calculation unit step may calculate the threshold value for switching to manual driving mode 304 Th.sub.0 based on a AS 100-width of the autonomous scooter 100 registered in the autonomous scooter 100 in advance or a general road width registered in the autonomous scooter 100 or in the map database 202b in advance.

In addition, a unit of the road width can be a meter [m], and when the amount of operation by the rider 101 relates to the steering operation, a unit of the threshold value for switching to manual driving mode 304 Th.sub.0 can be a degree which indicates the steering angle.

Accordingly, when the amount of operation is equal to or greater than the threshold value for switching to manual driving mode 304 (S9), the control unit 209 switches the driving state from autonomous driving mode 306 to manual driving mode 304 (S10). On the other hand, when the amount of operation is less than the threshold value for switching to manual driving mode 304 (S9), the control unit 209 continues to execute the autonomous driving mode 306.

According to the first embodiment, the threshold value for switching to manual driving mode 304 which is used for switching the driving state from autonomous driving mode 306 to manual driving mode 304 with respect to the amount of operation such as the steering operation by the rider 101 is calculated by the calculation unit step according to the surrounding environment of the autonomous scooter 100 recognized by the environment recognition unit step. Therefore, the amount of intervention of the driving operation by the rider 101 for switching the driving state from autonomous driving mode 306 to manual driving mode 304 conforms to the surrounding environment of the autonomous scooter 100.

In addition, according to the first embodiment, regardless of the presence or absence of the recognition of an obstacle, as the road width becomes narrower, it becomes easier to switch the driving state from autonomous driving mode 306 to manual driving mode 304, and thus, the ease of coping with the case of a narrow road width is improved. In addition, regardless of the presence or absence of the recognition of an obstacle, it becomes easier to switch the driving state from autonomous driving mode 306 to manual driving mode 304 when the autonomous scooter 100 travels on an intersection or a parking lot, and thus, the ease of coping with the case of the intersection or the parking lot is improved.

In addition, the environment recognition unit step may not include all of the obstacle recognition unit step, the road width recognition unit step, and may not execute all of the processing tasks. For example, any one or a plurality of configuration elements among the obstacle recognition unit step the road width recognition unit step may be omitted from the environment recognition unit step. When the road width recognition unit step and the recognition unit step are omitted, the calculation unit step may execute only the processing tasks of S4 and S5. In addition, when the obstacle recognition unit step and the road width recognition unit step are omitted, the calculation unit step may execute only the processing tasks of S6 and S7 after the processing of S3, and may not execute the processing of S8. In addition, when the obstacle recognition unit step and the recognition unit step are omitted from the environment recognition unit step, the calculation unit step may execute only the processing of S8 after the processing of S3, and may not execute the processing tasks of S4 to S7.

In addition, when the road width recognition unit step is omitted from the environment recognition unit step, the calculation unit step may execute only the processing tasks of S6 and S7 when the obstacle is not recognized in the processing of S4, and may not execute the processing of S8. In addition, when the facility recognition unit step is omitted from the environment recognition unit step, the calculation unit step may execute only the processing of S8 when the obstacle is not recognized in the processing step of S4, and may not execute the processing tasks of S6 and S7. In addition, when the obstacle recognition unit step is omitted from the environment recognition unit step, the calculation unit step may execute only the processing tasks of S6 to S8 after the processing of S3, and may not execute the processing tasks of S4 and S5.

Furthermore, when the environment recognition unit step includes the obstacle recognition unit step, the obstacle recognition unit step may recognize any of the distance between the obstacle and the autonomous scooter 100 and the type of the obstacle, and then, the calculation unit step may calculate the threshold value for switching to manual driving mode 304 according only to any of the distance between the obstacle and the autonomous scooter 100 and the type of the obstacle. In addition, when the obstacle recognition unit step recognizes the type of the obstacle and the calculation unit step calculates the threshold value for switching to manual driving mode 304 according to the type of the obstacle, the obstacle recognition unit step may recognize only any of whether the obstacle is a pedestrian and another AS 100 and whether the obstacle is a moving object or a stationary object, and then, the calculation unit step may calculate the threshold value for switching to manual driving mode 304 according to only any of whether the obstacle is a pedestrian or another AS 100 and whether the obstacle is a moving object or a stationary object.

Furthermore, when the environment recognition unit step includes the obstacle recognition unit step, the road width recognition unit step and the facility recognition unit step the processing tasks shown may be rearranged, such that, for example, the processing S4 may take place at the position of S6, and so on.

In greater detail FIG. 4 and FIG. 5 illustrates a function describing the threshold value for switching to manual driving mode 304 with respect autonomous driving mode 306 in which the travelling of the autonomous scooter 100 is controlled using the control center plan 208 generated by the control center plan 208 and the semi-autonomous driving state 607 in which the travelling of the autonomous scooter 100 is controlled based on both the control center plan 208 generated by the rider plan 101(RP) in which any of the amount of the navigation system 205 operation controls the acceleration operation and the braking operation by the rider 101 of the autonomous scooter 100 is reflected in the travelling of the autonomous scooter 100, based on any of the amount of the steering operation, the acceleration operation and the braking operation by the rider 101 of the autonomous scooter 100. In this case, when any of the amount of steering operation, the acceleration operation and the braking operation by the rider 101 of the autonomous scooter 100 during autonomous driving mode 306 is equal to or greater than a first threshold value, the control unit 209 switches the driving state from autonomous driving mode 306 to semi-autonomous driving state, and when any of the amount of steering operation, the acceleration operation and the braking operation by the rider 101 of the autonomous scooter 100 during the semi-autonomous driving state 607 is equal to or greater than a second threshold value which is greater than the first threshold value, the control unit 209 switches the fully autonomous driving mode 306—to a semi-autonomous driving state 607 semi-autonomous driving mode state to a manual driving mode 304. The calculation unit step can calculate the first threshold value and the second threshold value by a method similar to that of calculating the threshold value for switching to manual driving mode 304 described above.

Furthermore, in FIG. 4 and FIG. 5 a function describing the threshold value for switching to manual driving mode 304 with respect to the distance between the obstacle and the autonomous scooter 100 as illustrated in FIG. 4 may be stored in the autonomous scooter 100. In the example in FIG. 5, when the distance between the obstacle and the autonomous scooter 100 exceeds a value of 3, the calculation unit step calculates a threshold value for switching to manual driving mode 304 Th.sub.0 which is the reference of the threshold value for switching to manual driving mode 304 regardless of the type of the obstacle. In FIG. 5, a unit of the distance can be a meter [m], and when the amount of operation by the rider 101 relates to a steering operation, a unit of the threshold value for switching to manual driving mode 304 controls the steering angle. The units mentioned above are merely exemplary, and, for example, a unit of a different scale or an index could be used alternatively. Furthermore, particular values are mentioned above, but such values are merely examples of a predetermined value which may be set appropriately.

When the distance between the obstacle and the autonomous scooter 100 is equal to or less than 3 and exceeds 1 and the obstacle is a stationary object such as a lane line or a guardrail, the calculation unit step calculates a threshold value for switching to manual driving mode 304 which linearly decreases from the threshold value for switching to manual driving mode 304 Th.sub.0 at the time when the distance is 3 to the threshold value for switching to manual driving mode 304 Th.sub.1 at the time when the distance is 1. When the distance between the obstacle and the autonomous scooter 100 is equal to or less than 3 and exceeds 1 and the obstacle is another AS 100, the calculation unit step calculates a threshold value for switching to manual driving mode 304 which linearly decreases from the threshold value for switching to manual driving mode 304 Th.sub.0 at the time when the distance is 3 to the threshold value for switching to manual driving mode 304 Th.sub.2 which is lower than Th.sub.1 at the time when the distance is 1. When the distance between the obstacle and the autonomous scooter 100 is equal to or less than 3 and exceeds 1 and the obstacle is a pedestrian, the calculation unit step calculates a threshold value for switching to manual driving mode 304 which linearly decreases from the threshold value for switching to manual driving mode 304 Th.sub.0 at the time when the distance is 3 to the threshold value for switching to manual driving mode 304 Th.sub.3 which is lower than Th.sub.2 at the time when the distance is 1. When the distance between the obstacle and the autonomous scooter 100 is equal to less than 1, the calculation unit step calculates the threshold value for switching to manual driving mode 304 Th.sub.1 when the obstacle is a stationary object, calculates the threshold value for switching to manual driving mode 304 Th.sub.2 when the obstacle is a threat, and calculates the threshold value for switching to manual driving mode 304 Th.sub.3 when the obstacle is a pedestrian.

That is, when the distance between the obstacle and the autonomous scooter 100 is equal to or less than 3 and the obstacle is a pedestrian, the calculation unit step calculates a threshold value for switching to manual driving mode 304 which is lower than the threshold value for switching to manual driving mode 304 when the obstacle is another AS 100 with respect to the same distance between the obstacle and the autonomous scooter 100 (a first distance). In addition, when the distance between the obstacle and the autonomous scooter 100 is equal to or less than 3 and the obstacle is a moving object, the calculation unit step calculates a threshold value for switching to manual driving mode 304 which is lower than the threshold value for switching to manual driving mode 304 when the obstacle is a stationary object such as a lane line or a guardrail with respect to the same distance between the obstacle and the autonomous scooter 100 (a second distance).

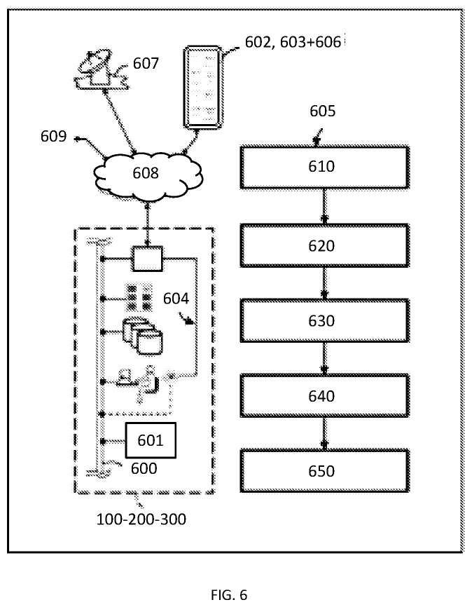

In greater detail FIG. 6 there is shown a tele-communication system 600 or “telematics unit,” provided for linking the rider wanted to communicate with the autonomous control system 200 from her or his smartphone 602 via rider interface display 603 on a smartphone, or from a smart device 211 to access features provided by one or more wireless network server systems 604 associated with any number of different systems that can link to the autonomous control system 200 and to the control center 300 by an onboard control panel 16 linked with external and auxiliary smart devices 211 or to a handheld wireless device such as the rider's smartphone 602 or wearable smart devices like a smart helmet having a virtual display to communicate with the systems 200-300 through the tele-communication system 600 via a wireless communication link.

It should be understood that the disclosed tele-communication system 600 method is not specifically limited to the operating environment shown here. Also, the architecture, construction, setup, and operation of individual components are generally known in the art. Thus, the following paragraphs simply provide a brief overview of one such exemplary system however, other systems not shown here could employ the disclosed method as well.

The smart devices 211 connect to the control panel 16 and the smartphone 602 carries out communication and control features of the tele-communication system 600 when using a software 605 application stored at the control panel 16. While some autonomous scooters 100 telematics units that can monitor autonomous scooter 100 functions and wirelessly communicate data over a wireless communication link. For instance, some autonomous scooters 100 use telematics units 600 may include a visual display that is capable of showing only one line of text at a time. At the same time, the tele-communication system 600 may include speech recognition capabilities that allow the rider 101 to recite verbal queries that may benefit from responses shown on additional display space. Smartphones often include a display screen 603 that is capable of showing graphical images and speakers or audio outputs that can audibly play sound. Additionally, or the control panel 16 linked to rider's smartphone 602 can communicate using short-range wireless communication by Bluetooth 606 protocols, cellular communications over a wireless AS network server system 603. Sensor data can be received by the smart devices 211 data, or by a smartphone 602 data from the tele-communication system 600 is stored in Cloud 607.

One of the networked devices that can communicate with the tele-communication system 600 is a smart device 211, 602. The smart device 211, 602 can include computer processing capability, a transceiver capable of communicating using a short-range wireless protocol, and a visual smart device display. In some implementations, the control panel 16 also includes a touch-screen graphical rider interface and/or a GPS capable of receiving GPS satellite signals 608 and generating GPS coordinates based on those signals. Examples of the smart devices may include the iPhone™ manufactured by Apple, Inc. and the Android™ manufactured by Motorola, Inc. While the smart devices may also include the ability to communicate via cellular communications using the wireless AS network server system, this is not always the case. For instance, Apple manufactures devices such as the iPad™, iPad, and the iPod Touch™ that include the processing capability, the display 603, and the ability to communicate over a wireless communication link. However, the iPod Touch and some iPads do not have cellular communication capabilities. Even so, these and other similar devices may be used or considered a type of smart device 211, 602 for the purposes of the method described herein.

When a rider 101 uses a control panel 16 or rider's smartphone 602, the tele-communication system 600 can then use the display 603 of that smart devices to show the rider 101 more detailed information, such as a menu containing a plurality of telematics service selections or geographical maps used to provide turn-by-turn directions. In this case, the tele-communication system 600 may no longer be limited by a single-line textual display installed on the autonomous scooter 100 but can display more detailed information using the control panel 16 or rider's smartphone 602. The smart device 211, 602 can also receive commands from the rider 101 and transmit the more detailed information to the telematics unit 601 in response to those commands. In another example, the tele-communication system 600 can also determine that the smart device 211, 602 is capable of greater wireless data communication speeds than can be achieved by the telematics unit. As a result, the tele-communication system 600 can leverage the wireless communication capability of the smart device 211, 602 a telematics unit 601 to transmit and receive data via the smart device 211, 602 over a cellular wireless communication system by transferring data between the telematics unit 601 and the smart device 211, 602 over the wireless communication link. In short, the combination of the display and control features of the smart device 211, 602 can be integrated within the autonomous scooter 100 for monitoring messages and instruction information, the tele-communication system may be referred to herein also as (TC System).

Some of the autonomous scooter 100 electronics is shown generally in FIG. 1 and includes a control panel 16 containing the telematics unit 601 configured with a microphone and an audio system. Some of these devices can be connected directly or indirectly connected using one or more network connections via a communications bus 609 for example, suitable network connections may include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

According to one embodiment, the tele-communication system 600 can be an OEM-installed (embedded) or aftermarket device that enables wireless voice and/or data communication over wireless AS network server system and via wireless networking so that the autonomous scooter 100 can communicate with call center, other telematics-enabled autonomous scooter 100, or some other entity or device. The telematics unit 601 preferably uses radio transmissions to establish a communications channel (a voice channel and/or a data channel) with wireless AS network server system so that voice and/or data transmissions can be sent and received over the channel. By providing both voice and data communication, tele-communication system 600 enables the autonomous scooter 100 to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center) and data communication (e.g., to provide GPS location data or autonomous scooter 100 diagnostic data to the call center), the system can utilize a single call over a voice channel and switch as needed between voice and data transmission over the voice channel, and this can be done using techniques known to those skilled in the art.

According to one embodiment, the tele-communication system 600 utilizes cellular communication according to either GSM or CDMA standards and thus includes a standard cellular chipset for voice communications like hands-free calling, a wireless modem for data transmission, an electronic processing device, one or more digital memory Cloud 607, and a dual antenna. It should be appreciated that the modem can either be implemented through software 605 that is stored in the telematics unit 601 and is executed by processors, or it can be a separate hardware component located internal or external to telematics unit 601. The modem can operate using any number of different standards or protocols such as EVDO, CDMA, GPRS, and EDGE. Wireless networking between the autonomous scooter 100 and other networked devices can also be Carried out using telematics unit 601. For this purpose, tele-communication system 600 can be configured to communicate wirelessly according to one or more wireless protocols, such as any of the IEEE 602.11 protocols, WiMAX, or Bluetooth 606. When used for packet-switched data communication such as TCP/IP, the telematics unit 601 can be configured with a static IP address or can set up to automatically receive an assigned IP address from another device on the network such as a router or from a network address server.

According to one embodiment, the processors of the smartphone 602 can be any type of device capable of processing electronic instructions including microprocessors, microcontrollers, host processors, controllers, autonomous scooter 100 communication processors, and application specific integrated circuits (ASICs). It can be a dedicated processor used only for tele-communication system 600 or can be shared with other autonomous scooter 100 systems. The one or processors executes various types of digitally-stored instructions, such as software 605 or firmware programs stored in memory or Cloud 607, which enable the telematics unit 601 to provide a wide variety of services. For instance, a number of processors can execute programs or process data to try out at least a part of the method discussed herein.

According to one embodiment, the tele-communication system 600 can be used to provide a diverse range of autonomous scooter 100 services that involve wireless communication to and/or from the autonomous scooter 100. Such services include: turn-by-turn directions and other navigation-related services that are provided in conjunction with the GPS-based autonomous scooter 100 navigation module; 991 notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 601, but are simply an enumeration of some of the services that the telematics unit 601 is capable of offering. Furthermore, it should be understood that at least some of the aforementioned modules could be implemented in the form of software 605 instructions saved internal or external to telematics unit 601, they could be hardware components located internal or external to telematics unit 601, or they could be integrated and/or shared with each other or with other systems located throughout the autonomous scooter 100, to cite but a few possibilities could utilize a method or bus 609 to exchange data and commands with the telematics unit.

For instance the GPS 201a receives radio signals from a constellation of GPS satellites. From these signals, the GPS 203 can determine autonomous scooter 100 position that is used for providing navigation and other position-related services to the autonomous scooter 100 driver. Navigation information can be presented on the display or can be presented verbally such as is done when supplying turn-by-turn navigation. The navigation services can be provided using a dedicated in-autonomous scooter 100 navigation module (which can be part of GPS), or some or all navigation services can be done via telematics unit 601, wherein the position information is sent to a remote location for purposes of providing the autonomous scooter 100 with navigation maps, map annotations (points of interest, restaurants, etc.), route calculations, and the like. The position information can be supplied to call center or other remote computer system, such as computer, for other purposes, such as fleet management. Also, new or updated map data can be downloaded to the GPS 203 from the call center via the telematics unit 601.

According to one embodiment, the electrical system elements 200-300 also include a number of autonomous scooter 100 rider interfaces that provide rider 101 with a means of providing and/or receiving information, including microphone, audio system connected to the control panel's virtual display for rider plan 101(RP). Various operator interfaces can also be utilized, as the rider 101 interface detailed of FIG. 2, FIG. 3A, FIG. 3B which are only an example of one particular implementation related to the control center 300.

As used herein, the term ‘autonomous scooter 100 rider interface’ broadly includes any suitable form of electronic device, including both hardware and software 605 components, which is located on the autonomous scooter 100 and enables an autonomous scooter 100 rider to communicate with or through a component of the autonomous scooter 100. Microphone provides audio input to the telematics unit 601 to enable the driver or other rider 101 to provide voice commands and AS 100ry out hands-free calling via the wireless AS network server system 606. For this purpose, it can be connected to an on-board automated voice processing unit utilizing human-machine interface (HMI) technology known in the art. The virtual display 603 allows manual rider input into the tele-communication system 600 to initiate wireless telephone calls and provide other data, response, or control input. Separate pushbuttons can be used for initiating emergency calls versus regular service assistance calls to the call center. Audio system provides audio output to a rider 101 and can be a dedicated, stand-alone system or part of the primary autonomous scooter 100 provided by speakers of the control panel 16 on the AB 100. According to the particular embodiment shown here, audio system is operatively coupled to both bus 614 and entertainment bus 615 and can provide AM, FM and satellite radio, and other multimedia functionality associated with the speakers and the microphone system. This functionality can be provided in conjunction with or independent of the infotainment module described above. Visual display is preferably a graphics display 603, such as a touch screen on the instrument panel or a heads-up display reflected off of the windshield, and can be used to provide a multitude of input and output functions.

According to one embodiment, the wireless tele-communication system 600 is preferably includes networking components required to connect wireless network server system with land network. Each cell tower includes sending and receiving antennas and a base station, with the base stations from different cell towers being connected to the MSC either directly or via intermediary equipment such as a base station operator. Cellular system can implement any suitable communications technology, including for example, analog technologies such as AMPS, or the newer digital technologies such as CDMA (e.g., CDMA8000) or GSM/GPRS. As will be appreciated by those skilled in the art, various cell tower/base station/MSC arrangements are possible and could be used with wireless system. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless AS network server system, a different wireless AS network server system in the form of satellite communication can be used to provide uni-directional or bi-directional communication with the autonomous scooter 100. This can be done using one or more communication satellites and an uplink transmitting station. Uni-directional communication can be, for example, satellite radio services, wherein programming content (news, music, etc.) is received by transmitting station, packaged for upload, and then sent to the satellite, which broadcasts the programming to subscribers. Bi-directional communication can be, for example, satellite telephony services using satellite to relay telephone communications between the autonomous scooter 100 and the control center 300. If used, this satellite telephony can be utilized either in addition to or in lieu of wireless AS network server system.

According to one embodiment, the land network may be a conventional land-based telecommunications network that is connected to one or more landline telephones and connects wireless AS network server system 606 to a call center. For example, land network 16 may include a public switched telephone network (PSTN) such as that used to provide hardwired telephony, packet-switched data communications, and the Internet infrastructure. One or more segments of land network could be implemented through the use of a standard wired network, a fiber or other optical network, a cable network, power lines, other wireless networks such as wireless local area networks (WLANs), or networks providing broadband wireless access (BWA), or any combination thereof. Furthermore, the call center need not be connected via land network 16, but could include wireless telephony equipment so that it can communicate directly with a wireless network, such as wireless AS network server system.

According to one embodiment, the computer can be one of a number of computers accessible via a private or public network such as the Internet. Each such computer can be used for one or more purposes, such as a web server accessible by the autonomous scooter 100 via tele-communication system 600 and wireless AS network server. Other such accessible computer can be, for example: a service center computer where diagnostic information and other autonomous scooter 100 data can be uploaded from the autonomous scooter 100 via the telematics unit 601; a client computer used by the autonomous scooter 100 owner or other subscriber for such purposes as accessing or receiving autonomous scooter 100 data or to setting up or configuring subscriber preferences or controlling autonomous scooter 100 functions; or a third party repository to or from which autonomous scooter 100 data or other information is provided, whether by communicating with the autonomous scooter 100 or call center, or both. A computer can also be used for providing Internet connectivity such as DNS services or as a network address server that uses DHCP or other suitable protocol to assign an IP address to the autonomous scooter 100.

According to one embodiment, the call center is designed to provide the autonomous scooter 100 electronics with a number of different system back-end functions and, according to the exemplary embodiment shown here, generally includes one or more switches servers, databases, live advisors, as well as an automated voice response system (VRS), all of which are known in the art. These various call center components are preferably coupled to one another via a wired or wireless local area network switch, which can be a private branch exchange (PBX) switch, routes incoming signals so that voice transmissions are usually sent to either the live adviser by regular mobile phone or to the automated voice response system using VoIP. The live advisor phone can also use VoIP as indicated by the broken line, VoIP and other data communication through the switch is implemented via a modem (not shown) connected between the switch and network. Data transmissions are passed via the modem to server and/or database. Database can store account information such as subscriber authentication information, autonomous scooter 100 identifiers, profile records, behavioral patterns, and other pertinent subscriber information. Data transmissions may also be conducted by wireless systems, such as 602.11x, GPRS, and the like. Although the illustrated embodiment has been described as it would be used in conjunction with a manned call center using live advisor, it will be appreciated that the call center can instead utilize VRS 88 as an automated advisor or, a combination of VRS 88 and the live advisor can be used.

As shown in FIG. 6 a charted method of controlling a tele-communication system 600 is exampled within the lined area. The method 600 begins at step 610 by storing software 605. The software 605 can be an application that controls autonomous scooter 100 functions. The software 605 can then be operated using the processing capabilities of the smartphone 602.

At step 620, the method detects the presence of the smart device 211, 602 that includes software 605 capable of remotely controlling the tele-communication system 600 via the wireless communication link between the tele-communication system 600 and the smart device 211, 602. The wireless communication link can be established using any one of the short-range communication protocols discussed above. The method 800 can be described using the Bluetooth 606 protocol. The wireless communication link can be established by pairing the smart device 211, 602 with the telematics unit 601. A query can be sent from the tele-communication system 600 to the smart device 211, 602 that asks whether software 605 for controlling the tele-communication system 600 is installed or saved at the smart device 211, 602. If the tele-communication system 600 receives a reply over the wireless communication link confirming the existence of such software 605, the tele-communication system 600 and the smart device 211, 602 can begin to communicate. The method 600 proceeds to step 630.

At step 630, the stored software 605 communicatively connects the smart device 211, 602 with the tele-communication system 600 via the wireless communication link. Once paired, the tele-communication system 600 and/or the smart device 211, 602 can direct the software 605 605 to communicate using the indicative protocol based on the Bluetooth 606 short-range wireless connections and exchange data, such as commands from the smart device 211, 602 to the telematics unit 601. The indicative protocol can wirelessly emulate serial cable line settings and the status of a serial port and can be used for the transfer of serial data. In this case, the tele-communication system 600 can directly connect with the smart device 211, 602 using the indicative protocol and the pairing of the tele-communication system 600 and the smart device 211, 602 can be Carried out based on the indicative protocol. Over the wireless communication link—using the indicative protocol or otherwise—the tele-communication system 600 can be controlled via commands that are represented by codes. In one example, these codes can be provided by a rider interface table (UIT) that includes a number for each action. The UIT can be stored at the tele-communication system 600 and the smart device 211, 602. That way, the UIT number can be sent over the short-range wireless communication protocol to the tele-communication system 600 or the smart device 211, 602 and that number can be interpreted and translated into the appropriate command. The method 600 proceeds to step 640.

At step 640, autonomous scooter 100 data for generating a telematics service menu offering telematics service commands 606 on the smart device 211, 602 display 603 of the smart device 211, 602 is transmitted from the tele-communication system 600 to the smart device 211, 602 via the wireless communication link and the selection of one of the telematics service commands made by a rider 101 is received. AS 100 data can generally relate to the operation of the autonomous scooter 100. Examples of autonomous scooter 100 data include turn-by-turn directions, diagnostic trouble codes (DTCs), and messages received from the call center. Telematics service selections that represent commands can be chosen at the smart device 211, 602 from one of the telematics service selections displayed on the smart device 211, 602 and received in response to autonomous scooter 100 data that is displayed at the smart device 211, 602. The tele-communication system 600 can provide not only autonomous scooter 100 data but also computer-readable information that the smart device 211, 602 can use to display a menu of telematics service selections. This computer-readable information can establish any one or more variables, such as the number of telematics service options presented to the rider 101, static data shown on the smart device 211, 602 display 603, the font of the characters displayed, the color of the smart device 211, 602 display 603, and more. In short, the computer-readable information can control the overall appearance of the information shown on the smart device 211, 602 display 603.

According to one embodiment, the telematics service menu used at the smart device 211, 602 can also provide master-slave status to the rider of the telematics service menu via the smart device 211, 602. That is, even though the tele-communication system 600 can receive selections from devices mounted on the autonomous scooter 100, such as virtual prompts, the telematics service menu use at the smart device 211, 602 may be encoded to override selections made from inputs other than those displayed on the smart device 211, 602. Thus, the smart device 211, 602 menu becomes the master control, while the other inputs are subordinate to the smart device 211, 602 menu. The method 640 proceeds to step 650.

At step 650, the selected telematics service command is transmitted to the tele-communication system 600 via the wireless communication link and one or more autonomous scooter 100 functions are controlled using the tele-communication system 600 based on the transmitted telematics service command. This selected command can control at least one function of the autonomous scooter 100. Using the menu shown on the smart device 211, 602 display 603, the rider 101 can select an option, such as by manually pressing the smart device 211, 602 display 603 where a button representing a selection is shown. In one example, the tele-communication system 600 can determine the rider 101 is experiencing some type of emergency, such as an autonomous scooter 100 accident. This can be determined when the tele-communication system 600 receives a signal from the rider 101 via 911 that, in this example, can detect the occurrence of an autonomous scooter 100 accident. In response, the tele-communication system 600 can generate a telematics service menu to send the smart device 211, 602 via the wireless communication link. Each of these selections can be made using the smart device 211, 602 and being sent to the tele-communication system 600 over the short-range wireless link is possible.

In another example, the rider 101 using the smart device 211, 602 can request turn-by-turn directions from one location to another location. The rider or rider 101 can verbally request these directions using the speech recognition function of the telematics unit 601. In response, the tele-communication system 600 can generate information to create a menu that includes a keypad for selecting address numbers and/or address alphabet characters for the rider 101 to select. This information can be transmitted via the wireless communication link to the smart device 211, 602 where the menu can be generated and shown on the smart device 211, 602 display 603. The rider 101 can then select the appropriate numbers and alphabet characters shown on the smart device 211, 602 display 603 thereby sending commands representing these selections to the tele-communication system 600 over the short-range wireless link. These commands can be sent to the tele-communication system 600 using the indicative protocol described above. The tele-communication system 600 can transmit the present location of the autonomous scooter 100 and the destination address entered using the smart device 211, 602 to the call center, which can return the turn-by-turn directions to the telematics unit 601. While the turn-by-turn directions can be audibly played in the autonomous scooter 100 using the audio system 36, the tele-communication system 600 can also send a geographical map to the smart device 211, 602 over the wireless communication link to be displayed on the smart device 211, or smartphone 602 with display 603. The menu shown on the smart device 211 may be used to select the address can then be replaced with an image of the geographical map. This map can include icons, such as an icon representing the destination on the map and an icon representing the autonomous scooter 100 as it moves along the map. The position of the autonomous scooter 100 icon on the map can be updated using GPS coordinates generated by the GPS 203 located on the autonomous scooter 100.

Other communications between the tele-communication system 600 and the smartphone has a mobile APP 650. For instance, the mobile APP 650 provides GPS mapping where information is received through GPS satellite signals, or generate GPS coordinates, to send GPS coordinates and use those received GPS coordinates in the execution and/or presentation of the turn-by-turn directions to drive the autonomous scooter 100. In another example, the call center can send messages relating to autonomous scooter 100 operation. These messages can be sent from the smartphone via the mobile APP 650. Accordingly, the mobile APP is designed with autonomous navigation software 605 for monitoring, communicating or managing operations of the autonomous scooter 100 via rider interface 101(1). The method 650 then ends.

Other communications in which the telematics unit 601 of an autonomous scooter 100 may involve transmitting a command that controls at least one function of the autonomous scooter 100 based on the received telematics service selection from the smartphone or provide other relevant commands related to autonomous control center plans.

Other communications in which the telematics unit 601 may involve the control center involving controlling a current position of the autonomous scooter 100 based on receiving information corresponding to at least one rider-selected starting location and a rider-selected destination location.

Other communications may involve the control center 300 involving determining GPS routes for an available autonomous scooter 100 to pick-up a rider based on the scheduling information and to drop-off rider at a location determined by GPS.

Other communications may involve the control center involving one of: renting an autonomous scooters 100 to transport riders or renting an autonomous scooter 100 for picking up a delivery payload; identify available autonomous scooters 100 to transport passengers, determine routes for the available autonomous scooters 100 to travel, the routes including delivery stops and being determined based on the scheduling information; receiving information corresponding to at least one virtual operator-selected starting location and a destination location.

Other communications may involve the control center virtually controlling one of: execute autonomous driving mode operation carried out during a driving state of an autonomous scooter 100; execute a manual driving mode operation carried out during a driving state of the autonomous scooter 100; switching the driving state from autonomous driving mode to manual driving mode when the value indicative of the degree to which the operation is carried out is equal to or greater than the threshold value for switching to manual driving mode; calculate the threshold value for switching to manual driving mode according to the status of the surrounding environment recognized by the environment recognizer, wherein the environment recognizer is configured to recognize an obstacle around the autonomous scooter 100 as information relating to the status of the surrounding environment the status being a threat or an obstacle; calculate the threshold value for switching to manual driving mode which becomes lower when a distance between the obstacle and the autonomous scooter 100 becomes smaller.

Other communications may involve the control center which may a processor for one of the following actions: determine GPS routes for an available autonomous scooter 100 to pick-up a rider based on the scheduling information then, to drop-off rider at a location determined by GPS routes; or determine the GPS routes by determining at least one route that includes the specific pickup location and the specific drop-off location corresponding to the premium travel request; or generate a GPS route for the autonomous scooter 100 or to predict a route based on prior routes taken by the autonomous scooter 100.

Other communications in which the control center plan for renting an autonomous scooter 100 may involve one of: receive scheduling information corresponding to at least one travel request and including a rider-selected starting location and a rider-selected destination location; provide memory configured to store map information including road information and preselected pick-up stops; receive information corresponding to at least one virtual operator-selected starting location and a destination location, and a processor coupled to the network access device configured to store information virtually; receive public transportation schedules, or the memory is further configured to store the public transportation schedules, to transmit the identified regions to corresponding autonomous scooters 100, 100a/100B that are available nearest to the pick-up stop; receive traffic data corresponding to AS 100 traffic or human traffic at various locations; identify the routes for the available autonomous scooters 100 to travel based on the public transportation schedules.

Other communications in which the control center plan may involve one of: receive scheduling information corresponding to a location requesting to pick-up delivery order; confirm a rider-selected starting location established to pick-up order then, delivery the order to a rider-selected destination location; or for delivering the payload to a rider-selected destination location or to a recipient.

The control center uses a kind of an autonomous scooter 100 leasing system based on Internet of Things it is characterized in that include Cloud Server 607 and with described Cloud Server At least one termination and at least one control terminal that communication is connected.

Described AS 100 termination, is arranged on the rentable autonomous scooter 100 information being uploaded to cloud network server 607.

For example, the autonomous scooter 100 uses Described information includes AS 100 id, current location and current state information, or describes current state information includes idle condition And use state.

Described control terminal, described solicited message is simultaneously uploaded to described cloud service by the solicited message for receiving user's input device through a tele-communication as exampled in FIG. 6.

For example, the autonomous scooter 100 uses solicited message includes target location and the user id that described AS 100 rental is located.

Described Cloud Server, for receiving described information of AS 100 and described solicited message, according to described information of AS 100 and request letter Breath determination AS 100 rental information, and accordingly the AS 100 rental information can be sent to control terminal by described.

Described control terminal, be additionally operable to display described can AS 100 rental information, the lease of receiving user's input instructs and will be described Lease instruction is sent to described Cloud Server, and described lease instruction includes the AS 100 id and described user id of a target AS 100.

For example, the autonomous scooter 100 uses a Cloud Server, is additionally operable to receive described lease instruction, generates solution based on described target AS 100 id and described user id Lock key, and described Personal Unlocking Key is sent to the corresponding AS 100 termination of AS 100 id of target, set up leasehold relationship.

For example, the autonomous scooter 100 uses a leasing system based on Internet of Things is characterized in that described AS 100 termination also For receiving described Personal Unlocking Key, and described target AS 100 is unlocked according to described Personal Unlocking Key.

For example, the autonomous scooter 100 uses the AS 100 termination method which is additionally operable to set up near-field communication with described control terminal, is additionally operable to receive described user id, is additionally operable to send described user id, and judges whether described user id is mated with described Personal Unlocking Key, If coupling, unlock target AS 100.

For example, the control center rental method based on Internet of Things it is characterized in that described control terminal also For scanning and obtaining the target AS 100, obtain the Bluetooth address of described AS 100 termination according to described AS 100 id, set up the Bluetooth connection of the AS 100 termination of described control terminal and described target AS 100, to realize near-field communication.

For example, the control center rental method based on Internet of Things according is characterized in that described cloud Server is additionally operable to inquire about and is in relaxed state and all AS 100 in the preset range of described target location for the described current location The information of the autonomous scooter 100 is described can be rental information.

For example, a kind of autonomous scooter 100 rent method based on Internet of Things is characterized in that include: at least one autonomous scooter 100 determination generates information of autonomous scooters 100 and described is uploaded to Cloud Serve, or include autonomous scooter 100 identification, a current location and current state information, based on a current state information includes idle condition and use state.

For example, described solicited message is simultaneously uploaded to described Cloud Server by the solicited message of arbitrary the control center receiving user's input, or described Solicited message includes target location and the user id that described an autonomous scooter 100 rental is located.

For example, described in described cloud server and described solicited message, determine according to described information of an autonomous scooter 100 and solicited messages of rental information, and AS 100 rental information can be sent to control center by described.

For example, described the control center show described can AS 100 rental information, the lease instruction of receiving user's input is simultaneously by described lease instruction It is sent to described Cloud Server, described lease instruction includes the AS 100 id and described user id of target autonomous scooter 100.

For example, lease instruction described in described cloud server, generates Personal Unlocking Key based on described target AS 100 id and described user id, And described Personal Unlocking Key is sent to the corresponding AS 100 termination id of target autonomous scooter 100, set up leasehold relationship, or receives Personal Unlocking Key, and unlocks described target autonomous scooter 100 according to described Personal Unlocking Key, and/or connects Receive described Personal Unlocking Key and target AS 100 unlocked according to described Personal Unlocking Key.

For example, described control terminal set up near-field communication and sends described user id, or receives described user id, and judges whether described user id is mated with described Personal Unlocking Key, if coupling, Then unlocks the target autonomous scooter 100.

For example, the autonomous scooter 100 rent method based on Internet of Things described AS 100 termination with Described control terminal sets up near-field communication, comprising: described control terminal scans and obtains the AS 100 id of target AS 100, according to described AS 100 id obtains the Bluetooth address of described AS 100 termination, sets up the indigo plant of described control terminal and the AS 100 termination of described target AS 100 Bluetooth connects, to realize near-field communication.

For example, the autonomous scooter 100 rent method based on Internet of Things being determined according to described information of AS 100 and solicited message can AS 100 rental information, comprising: inquiry is in relaxed state and described current The information of AS 100 determination of all AS 100 terminations in the preset range of described target location for the position is described can provide AS 100 rental information. The autonomous scooter system offers an autonomous scooter for personal use and for commercial rental service used to for riders to travel to the ideal destinations hands free since the scooter drives itself. The control center associated with a rental service plan and a battery charging service plan provided by a battery charging station, as detailed herein.

In greater detail FIG. 7 illustrates an autonomous scooter 100 battery charging system 700 that implements the communication and security features as described herein. Wherein the internal battery system 13 to provide a dock mechanism 15 regulated battery power 14(BP) from a battery pack with lithium batteries, or may include a secondary battery pack which is interchangeable. Wherein the electrical system 12 and wiring 12(W) connect the battery system 13 to internal electrical components of the autonomous scooter 100 to external auxiliary components such as a control panel 16.

Alternatively, another example of the internal dock mechanism 15 can use a capacitor which may involve batteries charged by autonomous scooter 100 battery charging system 700 whereby a first battery 14b or a secondary battery to be automatically charged, wherein the dock mechanism 5 connects at the dock 708 mechanism of the docking station 701 as exampled herein.

As shown, a docking station 701 is in communication with a control center 300 over the network. Respectively the docking station 701 is shown in this figure, it has been contemplated that multiple docking stations may be simultaneously connected with the control center 300, and includes multiple docks 702 a-702 c, or more. In some embodiments, the autonomous's docking station 701 may be implemented as each of the docks 702 . . . . Each of allows an autonomous scooter 100 to dock therein (e.g., to be received and locked at a dock of the autonomous scooter 100's docking station 701). For example, a shared autonomous scooters 100 . . . are shown to have docked at the dock 703 of the autonomous scooter 100 docking station 701. In some embodiments, a fleet of autonomous scooters 100+ may be implemented to come in contact with a locking mechanism 704 of the dock, which may secure (e.g., lock) the shared autonomous scooter 100 to the dock. The locking mechanism of the dock 703 may also obtain an identifier (e.g., a serial number) from a service plan generated by control center 300, of the shared autonomous scooters 100 . . . after successfully securing the shared autonomous scooters 100 . . . to the dock 703 such that the autonomous scooter 100 docking station 701 may generate a log entry for docking the shared autonomous scooters 100 . . . , which may include a time of docking the shared autonomous scooters 100 . . . and an identifier 705 of the shared autonomous scooters 100.

In some embodiments, the autonomous scooter 100 docking station 701 may include a communication module 706 for communicating with the control center 300 through a tele-communication network 707. For example, the communication module 706 may include a wireless transmitter for communicating with the control center 300 via the tele-communication network 707. In some embodiments, the autonomous scooter 100's 100 docking station 701 may establish and maintain a communication session (e.g., a TCP/IP communication session) with the control center 300. Through the communication session, the autonomous scooter 100 docking station 701 may transmit updated information (also referred to as docking station data) associated with the docking station 701, such as an operating status of the docking station 701, identities (and a number) of the shared micro-mobility fleet autonomous scooters 100 docked at the docking station 701 (e.g., such as the log entry for the shared autonomous scooters 100 . . . ), a charge status(es) of a fleet autonomous scooters 100+(e.g., the shared autonomous scooters 100 . . . ) docked at the multiple docks 703a-703c, or more at the docking station 701, information indicating physical condition(s) of the fleet autonomous scooters 100+ docked at the docking station 701, network information associated with the docking station 701, battery information associated with the docking station 701, and other information of the docking station 701 may be transmitted by the docking station to the control center 300 (e.g., on a periodic basis).

In some embodiments, the control center 300 may use the information obtained from the various autonomous scooter 100 docking stations (e.g., the docking station 701) to manage and facilitate the micro-mobility autonomous scooter 100 sharing service. For example, based on the information obtained from the docking station 701, the control center 300 may determine that the shared autonomous scooters 100 . . . is available for hire. Upon receiving a hiring request from a transportation requester for the shared autonomous scooters 100 . . . , the control center 300 may transmit an unlock signal to the autonomous scooters 100 and/or the docking station 701 for unlocking the shared autonomous scooters 100 . . . . Based on the unlock signal received from the control center 300, the docking station 701 may operate the locking mechanism associated with the dock 703 c to unlock the shared autonomous scooters 100 . . . .

In some embodiments, the control center 300 may monitor signals 708 transmitted by the various sensors, camera signals or smart devices are transmitted from the docking station 701 to the control center 300 according to a predetermined frequency (e.g., a predetermined interval 709). For example, the control center 300 may determine an autonomous scooter 100, such as a micro-mobility autonomous scooter 100, a ride-sharing car, a public transportation autonomous scooter 100, etc.) that is within a distance threshold (e.g., a range of a wireless short-range communication technology, such as Bluetooth®, etc.) from the docking station 701, based on a detected location of the autonomous scooter 100. In one example, the control center 300 may determine another shared autonomous scooter 100 (e.g., shared autonomous scooter 100 that is within the distance threshold from the docking station 701. The shared autonomous scooter 100 may be approaching the docking station 701 for docking, or may just be passing by. In some embodiments, the fleet autonomous scooter 100+ may be implemented as the shared autonomous scooter 100. In another example, the control center 300 may determine an autonomous scooter 100 that is within the distance threshold from the docking station 701 associated with the control center 300 and is or will be passing by the docking station 701 missing a scheduled battery charging service plan.

Alternatively, in some embodiments, the docking station 701 may also monitor the acknowledge signals transmitted from the control center 300 in response to the signals 708 and may detect one or more missing acknowledgement signals. As discussed above, each acknowledgement signal may correspond to a particular beat signal. For example, for each camera signal that the docking station 701 transmits to the control center 300, the docking station 701 may monitor a receipt of a corresponding acknowledgement signal from the control center 300. When the docking station 701 fails to receive a corresponding acknowledgement signal from the control center 300 (or fails to receive a predetermined number (e.g., 2, 5, 8, etc.) of acknowledgement signals) after a time threshold from sending the beat signal(s) (e.g., 2 seconds, 5 seconds, etc.), the docking station 701 may determine that the connection between the docking station 701 and the control center 300 has been interrupted (e.g., has become unavailable). In response to determining that the connection between the docking station 701 and the control center 300 is interrupted, the docking station 701 may detect any nearby autonomous scooters 100, such as any shared autonomous scooter 100 that is docked within a distance threshold from the docking station 701. The docking station 701 may establish a connection (e.g., a short-range wireless connection such as a Bluetooth® connection, an infrared connection, a radio-frequency communication channel, etc.) with the detected autonomous scooter 100.

Since the autonomous scooter 100 (e.g., the shared autonomous scooter 100 or rented autonomous scooter 100, etc.) may communicate with the control center 300 using a different connection than the docking station 701 (e.g., a different cellular network server, a different wireless communication technology, etc.), the connection between the autonomous scooter 100 and the management server may not be affected by the condition that has affected the connection between the docking station 701 and the control center 300. Thus, the control center 300 may transmit a signal to the autonomous scooter 100 to establish a connection (e.g., a short-range wireless connection such as a Bluetooth® connection, an infrared connection, a radio-frequency communication channel, etc.) with the docking station 701. The control center 300 may also instruct the autonomous scooter 100 to obtain docking station data from the docking station 701 and relay the docking station data to the control center 300.

Alternatively, when the docking station 701 fails to receive an expected acknowledgment signal from the control center 300 over a certain time period and determines connection has been lost, the docking station 701 may send a signal instructing a nearby autonomous scooter 100 (the same as the above nearby autonomous scooters 100) to connect with the docking station 701. For example, as discussed above, each micro-mobility autonomous scooter 100 may include smart devices like smart phone, iPad, Tablet, PC, etc. using a wireless communication technology. In some embodiments, at least some of the components of a shared autonomous scooter 100 (e.g., the autonomous scooter 100 controllers, the propulsion system, the battery etc.) may each wireless tele-communication 707 technology. Thus, any one of these components of the autonomous scooter 100 may be used to establish the connection with the docking station 701. The autonomous scooter 100 may then transmit a request for docking station data to the docking station 701 via the established connection achieved through docking mechanisms 15 and 708.

Accordingly, the docking station 701 may begin transmitting up-to-date or real-time docking station data to instruct the autonomous scooter 100 to relay the docking station data to the control center 300. In some embodiments, the docking station 701 may embed the docking station data in one or more signals and transmit the docking station data to the control center 300 via the autonomous scooter 100 in one or more signals 708. In another embodiment, the docking station 701 may instruct the autonomous scooter 100 to obtain docking station data from the docking station 701, such that the autonomous scooter 100 pulls data from the docking station 701 as opposed to the autonomous scooter 100 docking station sending the data. Regardless of how the autonomous scooter 100 obtains the data, the autonomous scooter 100 may, in turn, relay the docking station data (and/or the senor or camera signals) to the control center 300.

By relaying the docking station data via an intermediate autonomous scooter 100 to the control center 300, the control center 300 may continue to receive updated docking station data from the docking station 701 while the direct connection with the docking station 701 is temporarily unavailable. While the autonomous scooter 100 docking data is being transmitted to the control center 300 via the autonomous scooter 100, the docking station 701 may continue to attempt to transmit the signals 708 to the control center 300 through the direct connection. One or both of the docking station 701 and the control center 300 may continue to monitor the connectivity between the control center 300 and the docking station 701 based on whether they can receive the acknowledgement signals or the signals, respectively. In some embodiments, the control center 300 may continue to instruct the autonomous scooter 100 to obtain docking station data from the docking station 701 and/or the autonomous scooter 100 docking station may continue to transmit updated docking station data to the control center 300 via the autonomous scooter 100 (e.g., periodically) until a detection of the following condition: either (1) the connection between the docking station 701 and the control center 300 has been restored (e.g., the control center 300 begins receiving the beat signals from the docking station 701 again, or the docking station 701 begins receiving corresponding acknowledgement signals from the control center 300) or (2) the wireless short-range connection between the autonomous scooter 100 and the docking station 701 becomes unavailable (e.g., the autonomous scooter 100 has moved outside of the operational range of a wireless transmitter, etc.).

When the control center 300 and/or the docking station 701 determines that the wireless short-range connection between the autonomous scooter 100 and the docking station 701 becomes unavailable, the control center 300 and/or the docking station 701 may detect another autonomous scooter 100 (e.g., a second autonomous scooter 100) that is within the distance threshold from the docking station 701 and instruct the second autonomous scooter 100 to obtain and relay docking station data from the docking station 701 to the control center 300. The docking station 701 may continue to transmit updated docking station data to the control center 300 via an intermediate autonomous scooter 100 using the techniques described herein until the direct connection between the docking station 701 and the control center 300 is restored. When it is determined that the direct connection between the docking station 701 and the control center 300 is restored, the docking station 701 may revert back to transmitting the docking station data to the control center 300 directly using the communication session between the docking station 701 and the control center 300.

Through relaying docking station data via one or more autonomous scooters 100, the control center 300 may access docking station data from the various autonomous scooter 100 docking stations (e.g., the docking station 701) even when the connection with one or more autonomous scooter 100 docking station becomes unavailable. Thus, the control center 300 may determine the statuses of the autonomous scooters 100 in real-time without interruptions. For example, the control center 300 may determine whether an autonomous scooter 100 has been returned to the docking station 701 (e.g., the shared autonomous scooters 100+ that is approaching the docking station 701) and may be able to charge an amount to a user account based on an accurate time of returning the autonomous scooter 100 to the docking station 701. The control center 300 may also transmit instructions to unlock the autonomous scooter 100's dock mechanism 15 at the docking station 701 based on a request to rent the one or more autonomous scooters 100.

When the control center 300 receives the provisioning signal, the control center 300 may determine a key (e.g., a primary key such as key 710) for the autonomous scooter 100. In some embodiments, the key 710 determined for each shared autonomous scooter 100 may be different such that they are unique from each other. For example, the key 710 may be determined based at least in part on the identifier of the shared micro-mobility fleet autonomous scooter 100, such as a hashed key that is generated by hashing the identifier of the autonomous scooter 100 using a particular hashing function. In some embodiments, the key 710 is a 128-bit encryption key generated based at least in part on the identifier of the autonomous scooter 100. The control center 300 may transmit the key 710 to the autonomous scooter 100, as a response to the provisioning signal. Once the key 710 is received, the autonomous scooter 100 autonomous control system 200 of the shared autonomous scooter 100 may store the key 710 in its OTP memory. In subsequent operations of the autonomous scooter 100, the autonomous scooter 100 autonomous control system 200 is configured to power and/or unlock other components (e.g., the electrical system, the battery 14, other components, etc.) of the autonomous scooter 100 only upon receiving the key 710 from the management server. Thus, to unlock the autonomous scooter 100 (e.g., when the control center 300 has received a hiring (reservation) request from a user for hiring the autonomous scooter 100, etc.), the control center 300 may transmit an unlock signal that includes a key (e.g., the key 710) to the autonomous scooter 100. Upon receiving the unlock signal, the autonomous scooter 100 autonomous control system 200 of the autonomous scooter 100 may determine whether the key included in the unlock signal matches the key stored in its OTP memory. If the two keys match, the autonomous scooter 100 autonomous control system 200 may power and/or unlock the other components of the autonomous scooter 100.

In some embodiments, in addition to the autonomous scooter 100 autonomous control system 200, at least some of the other components of an autonomous scooter 100 (e.g., motor controller, the battery, etc.) may also include their own OTP memories for storing their respective keys. For example, after receiving the key from the control center 300, the autonomous scooter 100 autonomous control system 200 may transmit a key to at least some of the components of the autonomous scooter 100. The key that is transmitted to the other components may be the same key (e.g., the primary key) that was received from the control center 300.

By using the key-based unlocking process, in order to unlock (e.g., activate) the autonomous scooter 100 (e.g., to operate the autonomous scooter 100), the autonomous scooter 100 autonomous control system 200 of the shared autonomous scooter 100 must first receive the correct key from the control center 300, and the other components of the autonomous scooter 100 must receive their corresponding keys from the autonomous scooter 100 autonomous control system 200. Thus, a malicious user may not be able to take over the autonomous scooter 100 by simply removing the autonomous scooter 100 autonomous control system 200 from the autonomous scooter 100—without the autonomous scooter 100 autonomous control system 200 providing the corresponding key(s) to the other components, the other components would not operate. Furthermore, since multiple components require the key to operate, removing and/or replacing one or two components with generic versions of the components (e.g., without the key-based security measures) would not render the autonomous scooter 100 operable without authorization from the control center 300. For example, even if the malicious user replaces the motor controller with another motor controller that does not require a key to operate, the battery will not provide power to the propulsion system unless it receives the key from the autonomous scooter 100 autonomous control system 200.

In some embodiments, the autonomous scooter 100 autonomous control system 200 may be configured to authenticate the other components (e.g., verifying that the other components are associated with the dynamic transportation matching system, not shown) based on the key(s) (e.g., the secondary key) that was assigned (e.g., distributed) to the other components.

For example, the autonomous scooter 100 autonomous control system 200 may authenticate the components of the shared autonomous scooter 100 before unlocking the autonomous scooter 100. Thus, upon receiving the unlock request (and the key) from the control center 300, the autonomous scooter 100 autonomous control system 200 may attempt to authenticate the other components of the autonomous scooter 100 before unlocking the autonomous scooter 100. In some embodiments, the autonomous scooter 100 autonomous control system 200 may request the other components to provide the key that is stored in their respective OTP memories. The autonomous scooter 100 autonomous control system 200 may then determine whether the keys retrieved from the other components match the keys (e.g., the secondary key) that were assigned (distributed) to the other components during the provisioning of the autonomous scooter 100. If all of the keys from the other components match the assigned key, the autonomous scooter 100 autonomous control system 200 may authenticate the components, and may unlock the autonomous scooter 100. If any one of the keys from the components does not match (or no key is received from any one of the components), the autonomous scooter 100 autonomous control system 200 may determine that the corresponding component is not authenticated and may have been tampered with, or if the autonomous control system 200 fails to authenticate any one of the components of the autonomous scooter 100, controller may not unlock the autonomous scooter 100 (e.g., prevent the autonomous scooter 100 from being unlocked or from operating). The autonomous scooter 100 autonomous control system 200 may also transmit a signal to the control center 300 indicating that the autonomous scooter 100 has been tampered with.

When tampering with the micro-mobility autonomous scooter 100 a malicious user may also tamper with (e.g., remove, replace, etc.) the autonomous scooter 100 autonomous control system 200 of the autonomous scooter 100 such that the autonomous scooter 100 cannot transmit any tampering report to the control center 300 via the autonomous scooter 100 controller. While the autonomous scooter 100 autonomous control system 200 may be the only component in the autonomous scooter 100 that may communicate with the control center 300 (e.g., via a cellular network, etc.), many other components of the autonomous scooter 100 (e.g., the motor controller, the battery, etc.) may be equipped with a wireless short-range communication module (e.g., a Bluetooth® transmitter, etc.). Thus, in some embodiments, each of the components of the autonomous scooter 100 may detect tampering of any other component (e.g., removing, replacing, etc.) of the autonomous scooter 100. When a component detects that another component the battery of the autonomous scooter 100 autonomous control system 200, etc.) of the autonomous scooter 100 has been tampered with, the component may establish a connection (e.g., a wireless short-range connection) with an autonomous scooter 100 docking station (e.g., the docking station 701) or with another autonomous scooter 100 (e.g., the autonomous scooter 100). The component may then transmit a tampering report signal that may include the identifier of the autonomous scooter 100 to the autonomous scooter 100 docking station or the other autonomous scooter 100, and instruct the autonomous scooter 100 docking station or the other autonomous scooter 100 to relay the tampering report to the control center 300.

In another aspect of the disclosure, a mechanism for detecting tampering of the docking station 701 is provided. In some embodiments, each of the docking stations 701 may be configured to generate a verification code and transmit the verification code to the control center 300. The verification code, in some instances, may be generated as a hashed value based on data obtained from the control center 300. It is beneficial that the data on which the hashed value is based changes from time to time, such that hashed values generated based on outdated data can be expired and are no longer valid. The docking station 701 may include the verification code and data associated with the software 605 update data (e.g., a current system version, a current kernel version, etc.) in the beat signal. In some embodiments, the docking stations need not transmit the verification code in every beat signal, but only at a predetermined frequency (e.g., every day, every week, etc.) or in response to an event (e.g., a rebooting such as a power up event of the docking station 701). In some embodiments, the docking station 701 does not store a generated verification code in memory, but is configured to generate the verification code each time it is required to send the verification code to the control center 300 (e.g., when the docking station 701 is powered up, at a predetermined time, etc.).

Upon receiving the verification code from a docking station 701, the control center 300 may verify the verification code (e.g., determining whether the verification code corresponds to a hashed value of the most recent software 605 update data). The control center 300 may authenticate the docking station (e.g., has not been tampered with) if the verification code received from the docking station 701 is verified via software 605 711 in accordance with non-transitory instructions, program code, and/or data, can be stored on one or more non-transitory machine-readable mediums. It is also contemplated that software 605 identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

As used in this specification and claims, the terms “100A,” “100B,” “100A/100B,” “AS 100,” “controller,” “electronic motor,” “actuator,” “automatic,” “electronic components,” “autonomous components,” “signals,” “tele-communication,” “smart device,” “for example,” “for instance,” “such as,” “like,” “comprising,” “having,” “including,” and other language forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

It is to be understood that the foregoing is a description of one or more preferred exemplary embodiments of the invention. The invention is not limited to the particular embodiments disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiments will become apparent to those skilled in the art. All such other embodiments, changes, and modifications are intended to come within the scope of the appended claims.

I claim:

1. An autonomous vehicle system comprising:
a two wheel autonomous scooter (A-Scooter) requiring stabilization from an activated kickstand, or a three wheel autonomous scooter (A-Scooter) which does not require a kickstand, wherein the autonomous scooter utilizes a modular steering column configured to robotically steer the autonomous scooter with or without a rider onboard;
a propulsion system may include one of a motorized unit transmitting drive force to a front wheel or to a rear wheel in order to propel the autonomous scooter;
a control center associated with one of a rental service plan, a battery charging service plan provided by a battery charging station;
a control center associated with an autonomous scooter for personal use for riders to travel to the ideal destinations hands free since the scooter drives itself;
a manual driving mode for personal use in which a rider stands up to ride and the rider may opt to manual control the scooter or use the scooter with hands free during an autonomous driving mode;
the autonomous diving mode for personal use or for commercial use to travel to the ideal destination and origin plans where the rider can rent one or more autonomous scooters;
rider interface for executing an operation plan for manual driving mode which may involve a smartphone connection provided for remote instruction.

2. The autonomous vehicle system of claim 1 in which the rider interface for executing an operation plan for manual driving mode may involve one of:
steering with a handlebar;
a control panel connected on the modular steering column in view of the rider;
utilizing a throttle controller for manually controlling steering direction;
utilizing a brake controller for manually controlling speed;
accessing performance data gathered from sensors through a control panel providing with a virtual display for a rider input/output;
using a smartphone for remote instruction;
planning a GPS route.

3. The autonomous vehicle system of claim 1 in which an operation plan may involve:
autonomous driving mode utilizing a navigation system associated with a steering system linked to keep the autonomous scooter upright when the autonomous scooter is manned or unmanned;
a stabilization system linked to the internal sensors for controlling motion, position, and balance to keep the autonomous scooter upright;
a control unit provided to implement autonomous driving mode in real-time when activated by a rider of the autonomous scooter.

4. An autonomous vehicle system comprising:
an autonomous scooter (A-Scooter) including a handle bar having a throttle controller connecting to an electronic motor of a front wheel;
a brake controller via the control unit connecting to a braking device connecting to at least a front wheel or a rear wheel;
a manual kickstand, a robotic kickstand, or robotic training wheels which may autonomously raise or lower or be detached;
a stabilization system which may involve steering actuators, motor controllers, gyroscope or inertial measurement units for controlling motion and balance of the autonomous scooter when manned;
a combination of sensors and cameras to detect a threat, obstacle, mechanical motion, or to provide feedback and sensor input to the rider in real time, the sensor input based on a current motion or a current position of the autonomous scooter;
a control panel set in view of the rider, a virtual display for rider interface, a selection menu for accessing communication components which may include speakers, a microphone, Internet, Bluetooth associating with internal or external auxiliary components which may include smart devices, or a smartphone providing rider interface according to a rider plan.

5. The autonomous vehicle system of claim 1 and claim 4 in which the rider's plan may involve one of:
use a preferred mobile APP configured or the rider to interface with the autonomous scooter such that the rider can communicate with the autonomous scooter system or communicate with a control center remotely;
wherein the control panel providing a virtual readout of real-time performance data pertaining to one or more operations of the electronic components;
various processors providing instruction data, performance data, rider data, or external linked data;
wherein the rider may wirelessly link her or his smartphone, the autonomous scooter's control unit through wireless communication involving one of Wi-Fi, Bluetooth, or a telematic unit;
generating a GPS route of a current position of the autonomous scooter based on receiving information corresponding to at least one rider-selected starting location and a rider-selected destination location.

6. An autonomous vehicle system comprising:
a framework characterized as one of: scooters, tricycles, motorcycles, mopeds, golf carts, ATV's which use a modular steering column to steer;
wherein framework may include:
a control panel providing WIFI, Bluetooth and non-transitory computer readable medium having computer readable instructions executed by processor connected to an autonomous control system; and
a combination of sensors and cameras to determining a threat, obstacle, or mechanical motion;
a control center link providing autonomous navigation instruction associated with controlling steering, velocity and position of an autonomous scooter based on the service plan, wherein the control center link to provide feedback and sensor input to a virtual operator in real time, or sensor input based on a current motion or a current position of the autonomous scooter;
a navigation system for providing a control center plan generating a GPS route of a current position of the autonomous scooter based on at least one rider-selected starting location and destination location;
a stabilization system having gyro or IMU sensors;
a smartphone connected therein providing Internet, WIFI and Bluetooth configured to wirelessly link a rider to the autonomous control system, the smartphone APP systematically linking to the autonomous control system and configured to receive rider input in accordance with linked information received from sensor data to manually navigate the autonomous scooter to selected geographic areas, accordingly the smartphone utilizing an APP further comprising an operation start key associated with an identification code of a rider allows use of the autonomous scooter for various rider plans, control center plans, or service plans;
the control panel provides rider interface via a virtual a touch screen configured with a menu of control settings, performance status of autonomous scooter then storing performance data to memory in Cloud.

7. The autonomous vehicle system of claim 1, claim 6 in which the stabilization system which may involve steering actuators, controllers, gyroscope or inertial measurement units for controlling motion and balance of the autonomous scooter when manned or when unmanned.

8. The autonomous vehicle system of claim 1 further comprises one of:
a manual kickstand;
a kickstand autonomously activated by the control unit to maintain an upright position;
maintaining vertical axis of a front wheel and/or a wheel with respect to keeping the autonomous scooter upright;
a kickstand configured with actuating motors to raise and lower during manual driving mode;
a kickstand configured with training wheels provided for added balance support during autonomous driving mode;
the automated kickstand with training wheels may set at ground level when the autonomous scooter is unmanned such that balance is upheld when traveling or when no movement occurs.

9. The autonomous vehicle system of claim 1, claim 4 in which the rider plan may involve driving manually with no assistance from a navigation system.

10. The autonomous vehicle system of claim 1, claim 4, claim 6 in which the rider plan may involve assistance from the navigation system to switch to autonomous driving mode.

11. The autonomous vehicle system of claim 6 in which the autonomous scooter is configured for accomplishing at least one function involving a rider plan, a control center plan, a service plan or a combination thereof.

12. The autonomous vehicle system of claim 1 and claim 6 in which the control center involving controlling a current position of the autonomous scooter based on at least one rider-selected starting location and a rider-selected destination location.

13. The autonomous vehicle system of claim 6 in which the control center involving determining GPS routes for an available autonomous scooter to pick-up a rider based on the scheduling information and to drop-off the rider at a location determined by GPS.

14. The autonomous vehicle system of claim 6 in which the control center involving one of:
renting an autonomous scooters to transport riders or renting an autonomous scooter for picking up a delivery payload;
identify available autonomous scooters to transport passengers, determine routes for the available autonomous scooters to travel, the routes including delivery stops and being determined based on the scheduling information;
receiving information corresponding to at least one virtual operator-selected starting location and a destination location.

15. The autonomous vehicle system of claim 6 characterized as one of; a classified (level 1) having a manual driving mode with respect to the rider self-reliantly controlling the autonomous scooter, or can be classified (level 2) operating in semiautonomous driving mode with respect to the rider's riding plan, or can be classified as (level 3) operating in autonomous driving mode from a control center operator or driver in real-time with respect to one of; sensor and camera imaging data, a steering system, a navigation system, a stabilizing system, or configured for using an autonomous scooter battery charging system to charge one or more batteries.

16. The autonomous vehicle system of claim 6 in which the control center which may a processor for one of the following actions:
determine GPS routes for an available autonomous scooter to pick-up a rider based on the scheduling information then, to drop-off rider at a location determined by GPS routes; or
determine the GPS routes by determining at least one route that includes the specific pickup location and the specific drop-off location corresponding to the premium travel request; or generate a GPS route for the autonomous scooter or to predict a route based on prior routes taken by the autonomous scooter.

17. The autonomous vehicle system of claim 6 in which a plan for renting an autonomous scooter may involve one of:
receive scheduling information corresponding to at least one travel request and including a rider-selected starting location and a rider-selected destination location;
provide memory configured to store map information including road information and preselected pick-up stops;
receive information corresponding to at least one virtual operator-selected starting location and a destination location, and a processor coupled to the network access device configured to store information virtually;
receive public transportation schedules, or the memory is further configured to store the public transportation schedules, to transmit the identified regions to corresponding autonomous scooters that are available nearest to the pick-up stop;
receive traffic data corresponding to traffic or human traffic at various locations;
identify the routes for the available autonomous scooters to travel based on the public transportation schedules.

18. The autonomous vehicle system of claim 6 in which a plan may involve one of:
receive scheduling information corresponding to a location requesting to pick-up delivery order;
confirm a rider-selected starting location established to pick-up order then, delivery the order to a rider-selected destination location;
delivering the payload to a rider-selected destination location or to a recipient, whereby the payload is stored in at least one storage compartment;
provide memory configured to store map information including road information and preselected pick-up stops.

19. The autonomous vehicle system of claim 6 in which a service plan may involve one of renting an autonomous scooter for delivering a payload to a preselected starting location established to pick-up order, and may provide one or more storage compartments for transporting the delivery payload to a delivery location.

20. The autonomous vehicle system of claim 1 and claim 6 in which the control center configured to execute autonomous driving mode of an autonomous scooter by switching a driving state from autonomous driving mode to manual driving mode or vice versa indicative of various rider plans, control center plans, service plans or a combination thereof.
